(19) United States
(12) Patent Application Publication
(10) Pub. No.: US 2009/0164280 A1
(43) Pub. Date: Jun. 25, 2009

(54) Franchise Administration System With Automatic Compliance Monitoring and Reporting Features

(76) Inventors: Lauren Isbell, New York, NY (US); Scot Montgomery, Parsippany, NJ (US); David Gutt, Hardyston, NJ (US); Shashin Bhavsar, Fayetteville, GA (US)

Correspondence Address: MCCARTER & ENGLISH, LLP NEWARK, FOUR GATEWAY CENTER, 100 MULBERRY STREET, NEWARK, NJ, 07102, US

(21) Appl. No.: 12/191,743

(22) Filed: Aug. 14, 2008

Related U.S. Application Data
(60) Provisional application No. 60/964,612, filed on Aug. 14, 2007.

(51) Int. Cl. G06Q 10/00

(52) U.S. Cl. 705/7

(57) ABSTRACT

A franchise administration system having automatic compliance monitoring and reporting features is provided. Information about an entire franchise lifecycle, from initiation to termination, can be captured and managed in a central, web-based system. A user can define stipulations associated with a franchise agreement, as well as other milestones which must occur in accordance with the terms and conditions of the franchise agreement. The system monitors a franchisee's performance over time to determine whether the pre-defined stipulations are met. Defaults by the franchisee are automatically detected, classified according to severity, and processed by the present invention.

### RELATED APPLICATIONS

This application claims the benefit of U.S. Provisional Application Ser. No. 60/964,612 filed Aug. 14, 2007, the entire disclosure of which is expressly incorporated herein by reference.

### BACKGROUND OF THE INVENTION

1. Field of the Invention

The present invention relates to enterprise information management systems, and more particularly, to a franchise administration system with automatic compliance monitoring and reporting features.

2. Related Art

In many businesses, it is very important to be able to manage business information, including business workflows and project lifecycles, using a central information management system that can easily be accessed by employees. In particular, in the franchise industry, the ability to centrally manage franchise information, such as information about each franchisee, franchise administration, franchisee compliance with the terms and conditions of franchise agreements, and other information, is of critical importance. Indeed, if franchise information and workflows are not properly managed, significant losses in revenue can result.

In the past, various data processing systems and associated software have been developed for managing information about various aspects of franchise businesses. Unfortunately, many such systems only manage information about limited aspects of the business, such as property information or financial information. Additionally, such systems are often deployed on proprietary computing platforms (e.g., mainframe environments) which cannot easily be integrated with other computer systems or accessed via the Internet using a single, easy-to-navigate, web-based user interface. Still further, existing franchise information systems do not adequately monitor franchisees' performance in connection with franchise agreements, nor do they adequately detect, report, and process defaults by franchisees.

Accordingly, what would be desirable, but has not yet been provided, is a franchise administration system having automatic compliance monitoring and reporting features which addresses the foregoing limitations of existing franchise information systems.

### SUMMARY OF THE INVENTION

The present invention relates to a franchise administration system having automatic compliance monitoring and reporting features. The system provides a single, easy-to-navigate, web-based user interface which allows a plurality of individuals associated with a franchise business, such as franchisees, franchise administrators and/or managers, property managers, construction/design managers, compliance officers, quality assurance personnel, finance, marketing, and other individuals to collect, store, and access a variety of different types of information about a franchise business. Access to the system of the present invention could be by way of any suitable local computing system having Internet connectivity and web browsing capabilities. Information about an entire franchise lifecycle, from initiation to termination, can be captured and managed in a central, web-based system.

The present invention allows a user to define stipulations (e.g., conditions and events) associated with a franchise agreement, as well as other milestones which must occur in accordance with the terms and conditions of the franchise agreement. The system monitors a franchisee's performance over time to determine whether the pre-defined stipulations are met. Defaults by the franchisee are automatically detected and classified according to severity. The system automatically notifies franchise administrators and other personnel as to the default, and automatically transmits a default notification to the franchisee. The present invention can automatically initiate processes for handling the franchisee's default, depending on the franchisee's actions after receiving the notification.

### BRIEF DESCRIPTION OF THE DRAWINGS

The foregoing features of the invention will be apparent from the following Detailed Description of the Invention, taken in connection with the accompanying drawings, in which:

FIG. 1 is a diagram showing hardware components of the franchise administration system of the present invention;

FIG. 2 is a flowchart showing processing steps implemented by the franchise administration system of the present invention for collecting and storing franchise information;

FIG. 3 is a flowchart showing processing steps implemented by the franchise administration system of the present invention for automatically monitoring compliance by franchisees with franchise agreements;

FIG. 4 is a flowchart showing processing steps implemented by the franchise administration system of the present invention for automatically handling franchisee defaults;

FIGS. 5-15 are screenshots showing a navigation user interface generated by the present invention for collecting, storing, and accessing franchise information;

FIGS. 16-20 are screenshots showing a user interface generated by the present invention for capturing detailed facility information;

FIG. 21 is a screenshot showing a main user interface screen generated by the present invention;

FIGS. 22-24 are screenshots showing user interface screens generated by the present invention for searching for a desired franchise;

FIG. 25 is a screenshot showing the franchisee information portion of the navigation user interface of the present invention in greater detail;

FIGS. 26-28 are screenshots showing user interface screens generated by the present invention for collecting, storing, and accessing information about preferred franchise clients, affiliated sites, and affiliated brands;

FIGS. 29-30 are screenshots showing the franchise instance and franchise agreement portions of the navigation user interface of the present invention in greater detail;

FIGS. 31-34 are screenshots showing user interface screens generated by the present invention for collecting, storing, and accessing information about license agreements, stipulations, contract amendments, and third party agreements;

FIG. 35 is a screenshot showing the construction information portion of the navigation user interface of the present invention in greater detail;

FIGS. 36-37 are screenshots showing user interface screens generated by the present invention for collecting, storing, and accessing information about construction projects;

FIG. 38 is a screenshot showing the financial information portion of the navigation user interface of the present invention in greater detail;

FIG. 39-44 are screenshots showing user interface screens generated by the present invention for collecting, storing, and accessing information about accounts receivable, open transactions, operating statistics, reservation statistics, license rates, and available credits and/or cash;

FIG. 45 is a screenshot showing the compliance information portion of the navigation user interface of the present invention in greater detail;

FIGS. 46-53 are screenshots showing user interface screens generated by the present invention for collecting, storing, and accessing information about compliance restrictions, active defaults, cured defaults, pending compliance actions, quality assurance results, insurance carriers, terminated franchises, and reinstated franchises;

FIG. 54 is a screenshot showing a user interface screen generated by the present invention for collecting, storing, and accessing information about a franchise account; and

FIG. 55 is a screenshot showing a user interface screen for defining compliance monitoring tasks to be performed by the present invention in connection with a franchise.

### DETAILED DESCRIPTION OF THE INVENTION

The present invention relates to a franchise administration system having automatic compliance monitoring and reporting features. The system provides a single, easy-to-navigate, web-based user interface which allows a plurality of individuals associated with a franchise business to collect, store, and access a variety of different types of information about a franchise. Information about an entire franchise lifecycle, from initiation to termination, can be captured and managed in a central, web-based system. The present invention allows a user to define stipulations associated with a franchise agreement, as well as other milestones which must occur in accordance with the terms and conditions of the franchise agreement, and monitors a franchisee's performance over time to determine whether the pre-defined stipulations are met. Defaults by the franchisee are automatically detected, classified according to severity, and processed by the present invention.

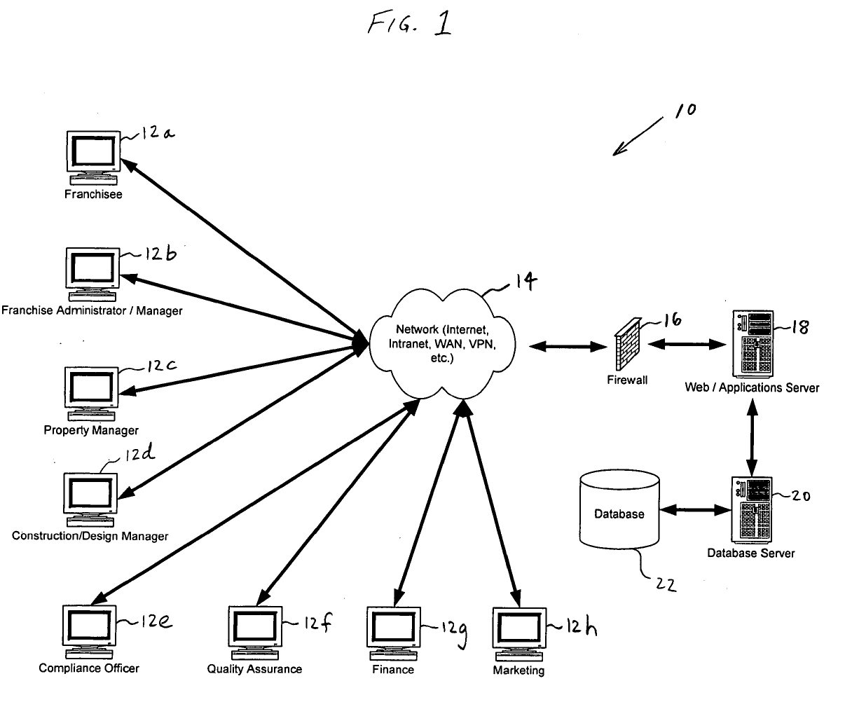

FIG. 1 is a diagram showing hardware components of the franchise administration system of the present invention, indicated generally at 10. The system 10 allows a plurality of individuals associated with a franchise business to collect, store, and access information about a variety of aspects about the business, including an entire franchise lifecycle, using a simple, easy-to-navigate user interface accessible via a network, such as the Internet. Thus, as shown, a plurality of individuals having local computer systems 12a-12h can access the present invention via a network 14, such as the Internet, a corporate intranet, a wide area network (WAN), a virtual private network (VPN), etc. The individuals could include one or more franchisees, a franchise administrator/manager, a property manager, a construction/design manager, a compliance officer, a quality assurance officer, an employee of a finance department, an employee of a marketing department, and any other individual associated with a franchise business. For example, if the franchise business is a hotel franchise, the franchisees could include individuals at specific hotel locations throughout the world. The local computer systems 12a-12h could comprise any suitable computing equipment with Internet connectivity and web browsing capabilities, and could include, but are not limited to, a desktop personal computer (PC), a laptop, a personal digital assistant (PDA), a pocket PC, a cellular telephone, or any other suitable computing device. The local computing systems 12a-12h could communicate with the network 14 using any suitable wired or wireless networking technology.

The system 10 also includes a web/applications server which communicates with the local computer systems 12a-12h via the network 14. Optionally, a firewall 16 could be provided for secure access to and protection of the server 18. The web/applications server 18 is programmed in accordance with the present invention to provide each of the local computer systems 12a-12h with a secure website and an associated graphical user interface (GUI) for collecting, storing, and accessing franchise information. The server 18 is in communication with a database server 20 and its associated database 22. The database server 20 stored franchise information in the database 22, and could operate any suitable database package and associated operating system, such as the ORACLE database package produced by Oracle, Inc. The web/applications server could operate suitable web access software, such as ORACLE Applications, also manufactured by Oracle, Inc. Such software packages include software modules for generating GUI screens which can be utilized and/or modified to generate the user interface screens of the present invention as depicted and described herein. Of course, any other suitable software packages could be utilized to generate the GUI screens of the present invention. The servers 18 and 20 could comprise any suitable computing hardware, such as multi-processor servers and associated storage equipment (e.g., a storage area network (SAN)), and could operate any suitable operating system such as WINDOWS Advanced Server by Microsoft, Inc., UNIX, or LINUX. As will be readily appreciated by one of ordinary skill in the art, the configuration of server hardware, as well as the types, quantities, and configurations of such equipment, could be modified as desired without departing from the spirit or scope of the present invention.

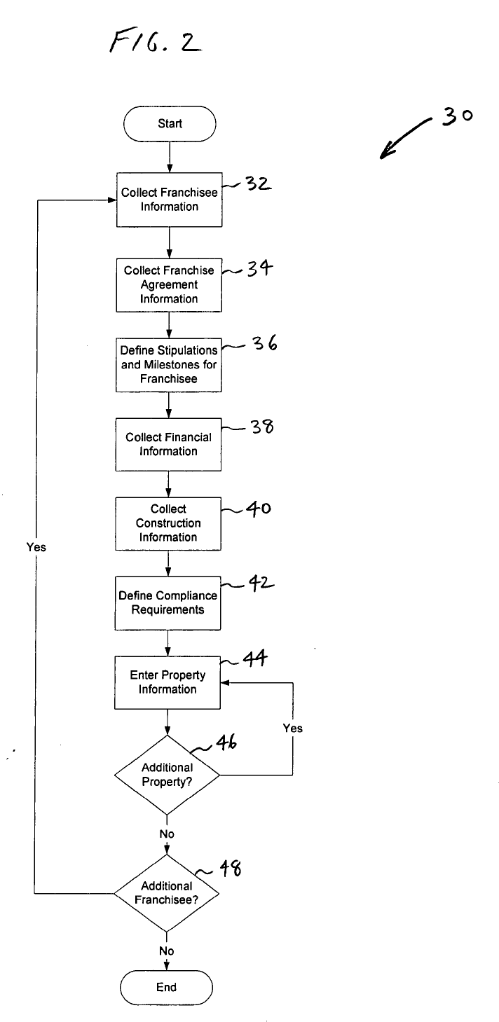

FIG. 2 is a flowchart, indicated generally at 30, showing processing steps implemented by the franchise administration system 10 of the present invention for collecting and storing franchise information. Importantly, the present invention allows for a variety of franchise information to be collected using a simple, easy-to-navigate, web-accessible GUI. In step 32, the present invention allows a user to provide information about one or more franchisees. In step 34, information about one or more franchise agreements is provided. This information can be gathered electronically by the present invention (i.e., by a franchise administrator entering the information in a GUI using the computer 12b), or it can be acquired from hardcopy agreements by manual data entry or through the use of optical character recognition (OCR). In step 36, important stipulations and milestones associated with one or more franchise agreements are entered. This information could include, for example, dates of important events which are required by an agreement to occur, tasks which must be performed by a franchisee, quantities required to be met (e.g., for a hotel franchisee, a monthly total of occupants required for a given facility), etc. In step 38, financial information about a franchisee is entered. Optionally, in step 40, information about a construction project associated with a particular franchisee's building could be entered. In step 42, compliance requirements are defined by the user. This information could include information about agreement start and termination dates, previous defaults by a particular franchisee, and other information. In step 44, information about a property owned or occupied by a franchisee is entered. In step 46, a determination is made as to whether additional properties owned or occupied by the franchisee exist. If a positive determination is made, step 44 is repeated, so that additional property information can be entered. Otherwise, the information acquired in steps 32-44 is stored in the database 22 by the database server 20 of FIG. 1. In step 48, a determination is made as to whether information about an additional franchisee is to be entered. If so, step 32 is carried out and the processes discussed above in connection with FIG. 2 repeated so that additional franchisee information can be collected and stored in the database 22. Otherwise, processing ends.

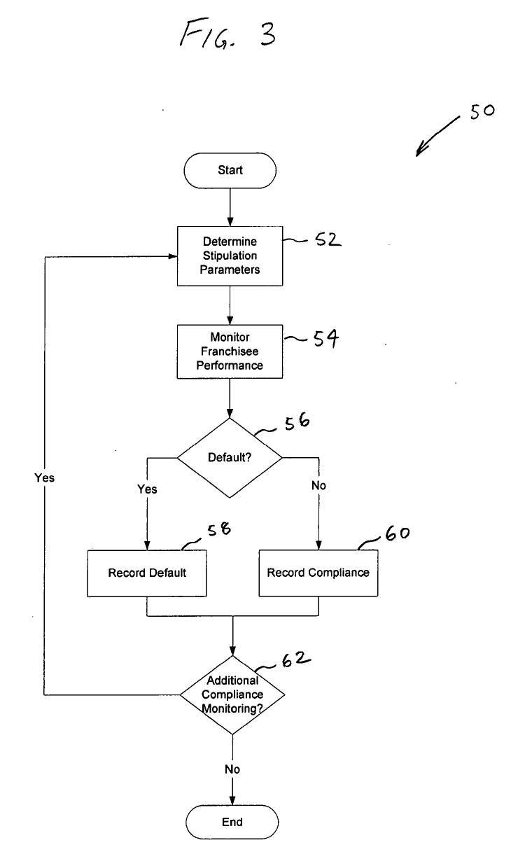

It is noted that the data collection steps illustrated in FIG. 2 need not be carried out in the specific sequence illustrated therein, and that a user can choose to enter only information pertinent to his or her job responsibility. Thus, for example, a construction manager can utilize the present invention to collect, store, and access information about one or more construction projects at a franchisee property, while a marketing manager can utilize the present invention to collect, store, and access information about marketing efforts at a franchisee location. Thus, the present invention flexibly allows franchise data to be captured from a variety of sources, at a central location accessible via the Internet. Additionally, it is noted that the acquired data can be stored by the database server 20 of FIG. 1 in the database 22 in any suitable sequence and at any suitable time. The information collected in FIG. 3 is discussed hereinbelow in greater detail in connection with FIGS. 5-55.

FIG. 3 is a flowchart showing processing steps, indicated generally at 50, which are implemented by the franchise administration system 10 of the present invention for automatically monitoring compliance by franchisees with franchise agreements. Importantly, the present invention allows for the automatic monitoring of a franchisee's compliance with the terms and conditions of a franchise agreement, as well as the automatic detection of defaults by the franchisee and handling of such defaults. In step 52, parameters corresponding to one or more stipulations associated with a franchise agreement are determined by the present invention. As mentioned above, stipulations could be defined by a user and stored in the database 22, manually entered by a user via a GUI, or scanned from hardcopy documents using OCR software. The stipulations define important events which are required to occur per the terms of a franchise agreement. Thus, for example, a stipulation regarding the minimum monthly number of occupants at a franchisee's hotel could be defined and stored in the database 22. Of course, any other desired stipulation could be provided.

In step 54, the franchisee's performance related to the stipulation is monitored by the present invention. Such monitoring could be carried out in a number of ways. For example, the present invention could be programmed to generate an e-mail or other type of electronic communication which is sent to the franchisee and which requires the franchisee to notify the present invention (e.g., using a web-based GUI) about the franchisee's performance on a regular basis. Also, a franchise administrator could be dispatched to the franchisee's location to periodically monitor the franchisee's performance, and could utilize one of the local computing systems shown in FIG. 1 to record information about the franchisee's performance in the database 22 by way of the network 14. Still further, the present invention could be configured to be in electronic communication with a franchisee's in-house data processing system and to remotely acquire performance information from such a system for the purposes of evaluating the franchisee's performance. Other ways of acquiring information about the franchisee's performance, such as by acquiring performance information from hardcopy documents generated by the franchisee (using OCR software), are also possible.

In step 56, a determination is made by the present invention as to whether the franchisee has not met the required stipulation (i.e., defaulted). If a positive determination is made, step 58 occurs, wherein the default is recorded in the database 22 of FIG. 1. Otherwise, if a negative determination is made, step 60 occurs, wherein the franchisee's satisfactory compliance is recorded in the database 22. In step 62, a determination is made as to whether additional compliance monitoring is required. If a positive determination is made, step 52 is carried out and the processing steps of FIG. 3 repeated so that additional compliance monitoring can occur. Otherwise, processing ends. It is noted that the processing shown in FIG. 3 could be programmed to be carried out at specific dates specified by the user, or whenever desired by the user by issuing a monitoring command.

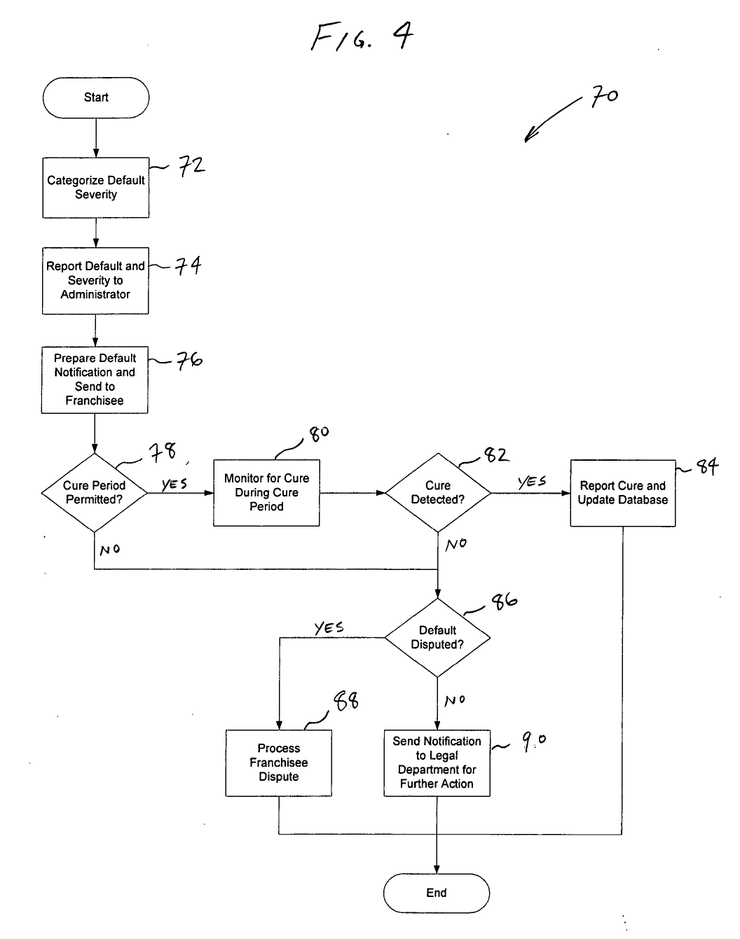

FIG. 4 is a flowchart showing processing steps, indicated generally at 70, which are implemented by the franchise administration system 10 of the present invention for automatically handling franchisee defaults. The steps shown in FIG. 4 allow the present invention to automatically categorize the severity of a franchisee's default, and to process defaults with minimum user intervention. In step 72, when a default is detected, it is categorized according to its severity. Severity categories could be pre-programmed, or could be specified by a user. For example, automatic “low” severity categorization could be programmed to occur where a franchisee fails to meet a stipulated occupancy goal for a given month by a small amount. An automatic “high” severity categorization could be programmed to occur where a franchisee fails to perform a material task required by a franchise agreement, such as to complete a phase of a construction project at a specific date. Of course, other categories are possible. In step 74, the default and its associated severity category is reported to a franchise administrator, typically by way of e-mail although other communication media could be utilized. In step 76, a default notification is generated by the present invention and communicated to the franchisee. Such communication could be in the form of a printed notice which is mailed to the franchisee, a facsimile which is automatically transmitted to the franchisee, or an electronic communication (such as an e-mail, text message, etc.) which could be transmitted to the franchisee by the present invention. Other forms of communication are possible, such as by telephone using an Interactive Voice Response (IVR) system.

In step 78, after the default notification is sent to the franchisee, a determination is made as to whether a cure period is permitted. This permission could be defined by a franchise administrator using the present invention and stored in the database 22. If a negative determination is made, control passes to step 86 discussed below. If a positive determination is made, step 80 occurs, wherein the franchisee's performance is monitored during a pre-defined period of time allotted for curing the default. Such monitoring could be carried out in the same ways described above in connection with FIG. 3. In step 82, a determination is made as to whether a cure (i.e., performance of a stipulated event by the franchisee) has been detected. If so, step 84 is invoked, wherein the cure is reported to a franchise administrator and the database 22 is updated. Otherwise, step 86 is invoked.

In step 86, a determination is made as to whether the default is disputed by the franchisee. If a positive determination is made, step 88 is invoked, wherein the dispute is processed in accordance with a pre-defined procedure. Such a procedure could include determining whether the severity of the default is sufficiently low to excuse the default, and if so, excusing it. It could also include granting an extension to the franchisee to allow for additional time to cure the default, or referring the dispute to a committee within an organization for resolution. If a negative determination is made, step 90 is invoked, wherein a notification is sent to the franchise's legal department for further action.

FIGS. 5-15 are screenshots showing a navigation user interface 130 generated by the present invention for collecting, storing, and accessing franchise information. As shown in FIG. 5, the interface 130 includes a navigation toolbar 132, an account information portion 134 for collecting, saving, and accessing information about a franchise account (including, but not limited to, contact information, account number, taxpayer identification number, etc.), and a detailed information display region 136 (organized by user-accessible tabs) for collecting, saving, and accessing information about franchises. As shown in FIG. 5, the display region 136 includes a “Dashboard” folder 138 for collecting, saving, and accessing information about various aspects of a franchise, including a franchisee information portion 140 for collecting, saving, and accessing information about a franchisee, a franchise instance portion 142 for collecting, saving, and accessing information about a specific franchise location, a franchise agreement portion 144 for collecting, saving, and accessing information about one or more franchise agreements, a construction information portion 146 for collecting, saving, and accessing information about one or more construction projects associated with a franchisee, and a financial information portion 148 for collecting, saving, and accessing information about a franchisee's financial history. As can be appreciated, access limitations on each of the information portions 140-148 can be imposed as desired, according to each user's role. An importance indication column 150 could be provided for each of the information portions 140-148 to indicate the relative importance of each item of information being displayed. A “View by Account” checkbox 152 could also be provided for viewing franchise information according to franchise accounts.

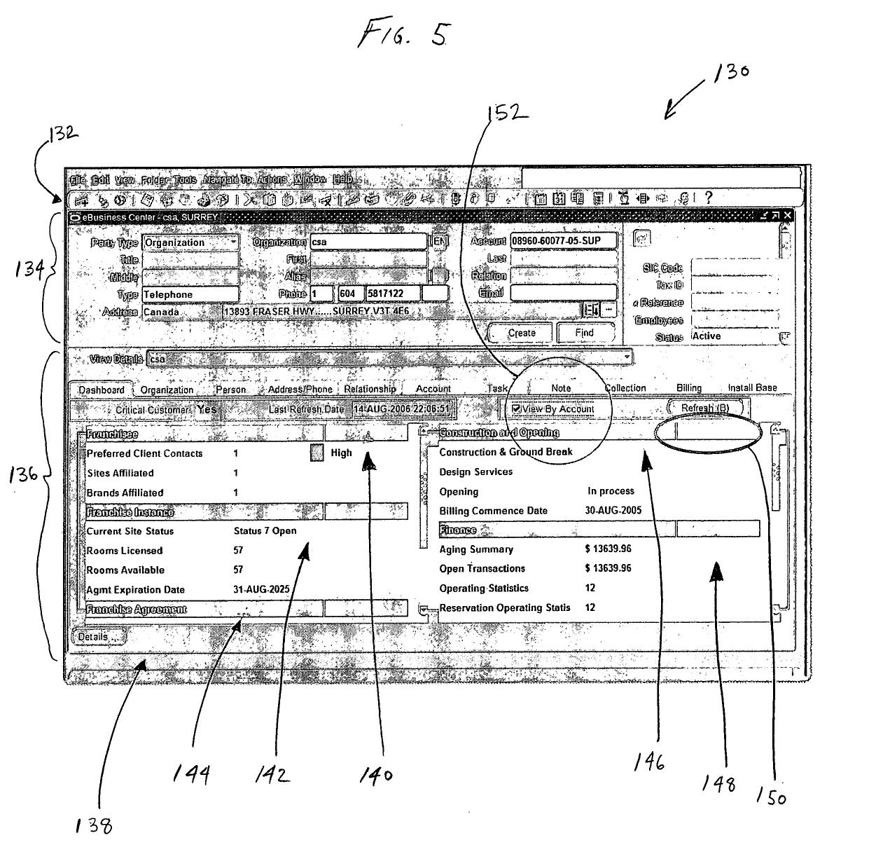

The “Organization” folder 154 of the navigation user interface 130 is shown in FIG. 6. As can be seen, this folder allows for the collection, storage, and accessing of information relating to a business organization associated with one or more franchisees. Information stored includes, but is not limited to, status, business alias, category, legal structure, business scope, number of employees, year established, fiscal year end, current revenue, projected revenue, among other information. Additional details and restrictions can be specified and/or accessed by clicking on the “Details” and “Restrictions” buttons on the folder 154.

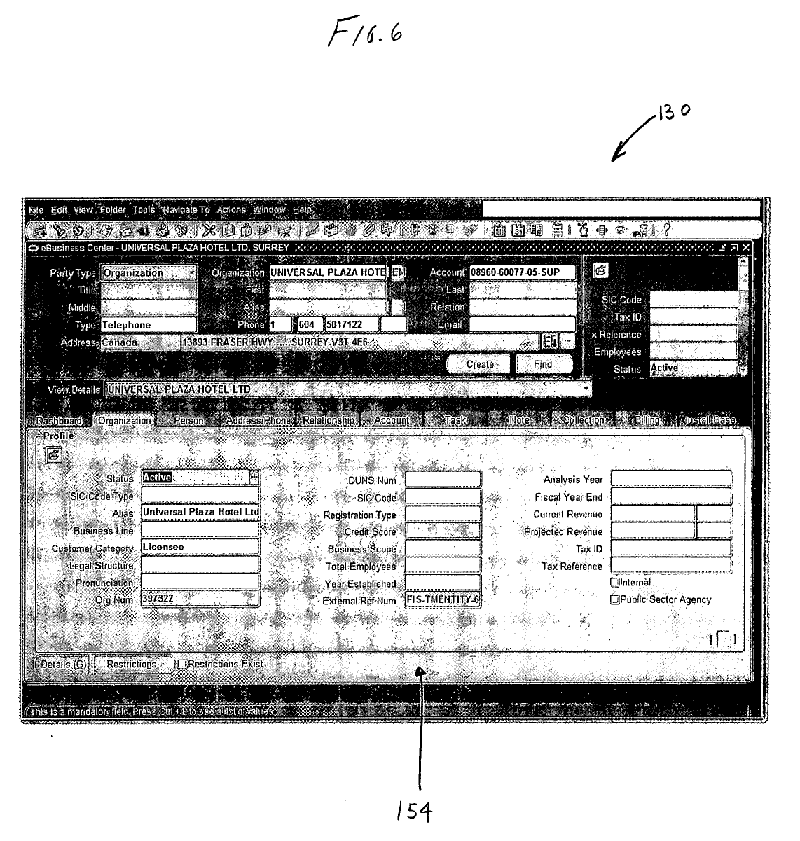

The “Person” folder 156 of the navigation user interface 130 is shown in FIG. 7. The folder 156 allows for detailed information about an account representative identified in fields 158 of the account information 134 of the navigation user interface 130 to be collected, stored, and accessed. Information stored includes, but is not limited to, personal profile information such as pronunciation of the person's name, salutation, marital status, gender, date of birth, native language, as well as business profile information including the person's primary role, job title, department, and other information.

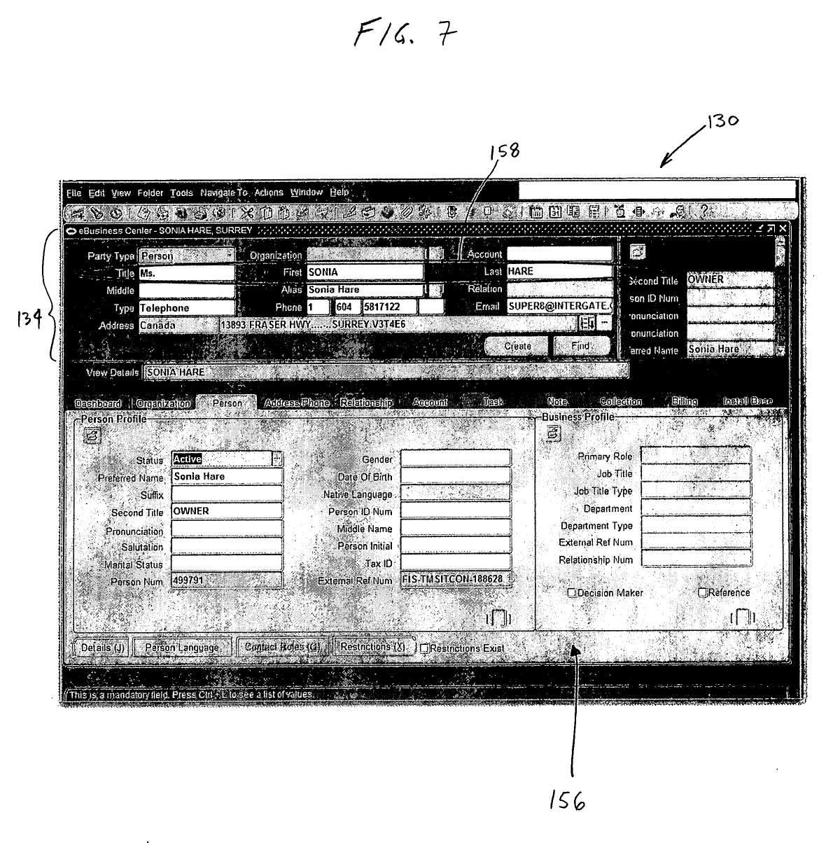

The “Address/Phone” folder 160 of the navigation user interface 130 is shown in FIG. 8. The folder 160 allows for detailed information about one or more franchisee addresses to be collected, stored, and accessed, as well as contact methods and numbers (e.g., telephone, fax, cell phone, etc.) Additional fields are provided for allowing the user to specify whether or not to contact a person using a particular number, and for indicating a primary or an inactive address. The ability to record and toggle between active and inactive contact information is also provided by way of the “Active,” “Inactive,” and “All” radio buttons appearing on the folder 160.

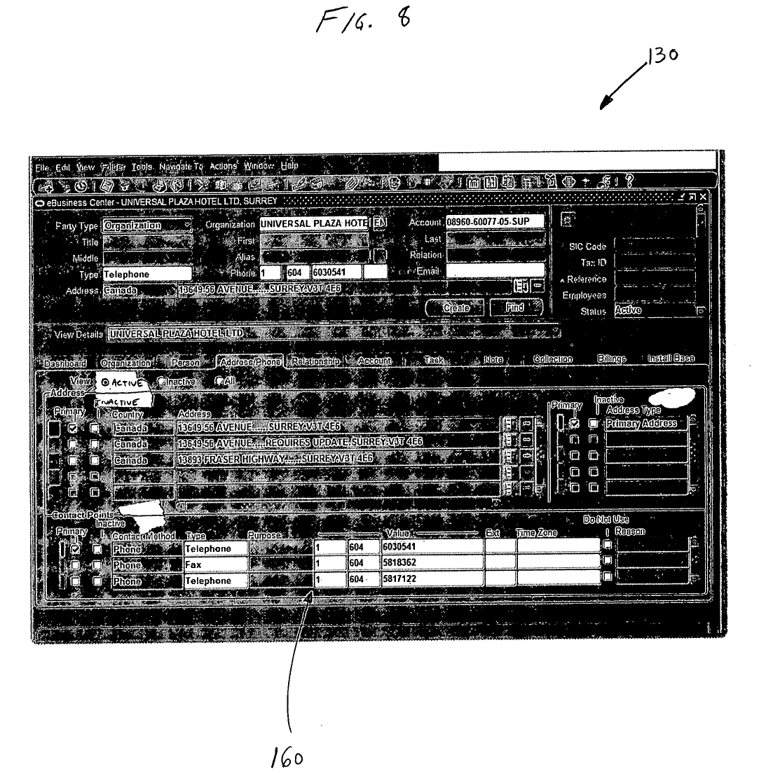

The “Relationship” folder 162 of the navigation user interface 130 is shown in FIG. 9. The folder 162 allows for detailed information about relationships (either personal or organizational) associated with a franchise to be collected, stored, and accessed. Fields 164-174 are provided for recording relationship information, identity of the relationship (either personal or organizational), the name of the relationship, start and end dates of the relationship, details of the relationship, and a number associated with the relationship. The ability to record and toggle between active and inactive relationships is also provided by way of the “Active,” “Inactive,” and “All” radio buttons appearing on the folder 162. The ability to sort relationships is also provided.

The “Account” folder 180 of the navigation user interface 130 is shown in FIG. 10. The folder 180 allows for detailed information about franchise accounts to be collected, stored, and accessed. The information stored includes, but is not limited to, account name, account number, site name, account status, property and chain name, number, tax code, refund method, suspension and termination dates, statement cycle, and tax rounding rules.

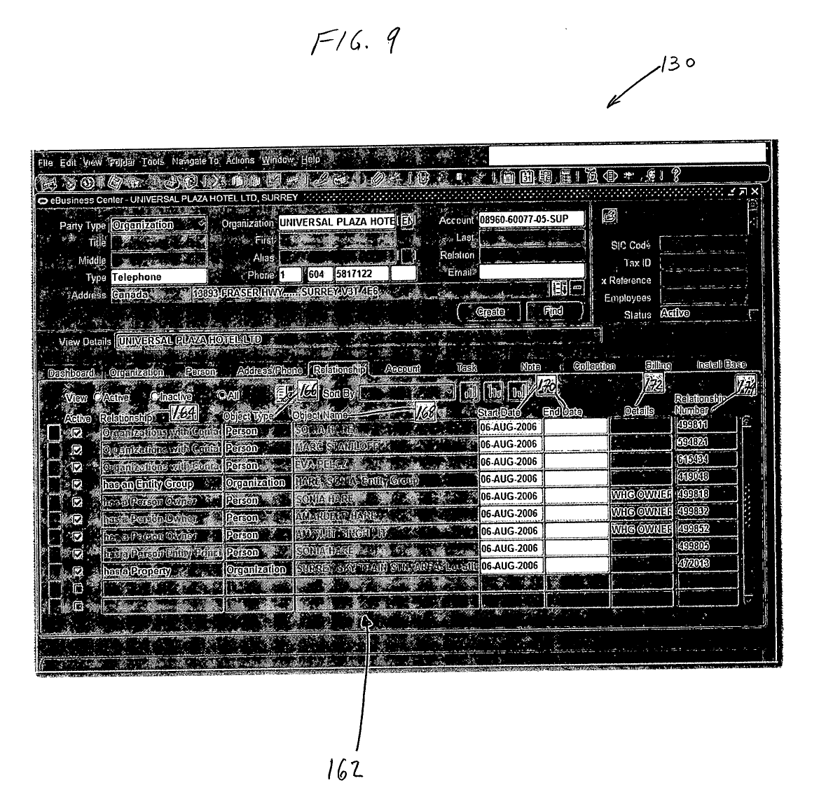

The “Task” folder 182 of the navigation user interface 130 is shown in FIG. 11. The folder 182 allows for detailed information about tasks to be performed by a franchisee (typically, tasks associated with franchise agreement stipulations) to be defined, stored and accessed. The information stored includes, but is not limited to, task type, task name, priority status (low, medium, or high), current status of task (e.g., pending), contact person, franchisee time zone, task start date and time, owner type, assignee type, assignor identification, description of the task, subject description, phone number of franchisee, type of date (e.g., a scheduled date), and task end date. Also provided is the ability to designate one or more tasks as private by clicking on a “Private” checkbox in the form 182, as well as the ability to provide additional detailed task information and task notes. Moreover, one or more tasks can be designated by a user as being related one or more other tasks, so as to cross-reference tasks.

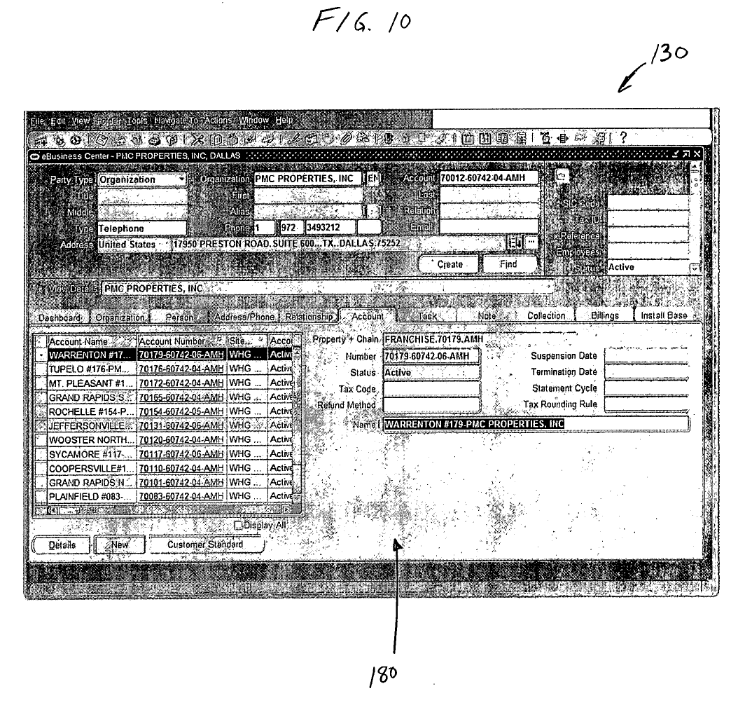

The “Note” folder 184 of the navigation user interface 130 is shown in FIG. 12. The folder 184 allows for detailed notes about a franchise to be entered, stored, and accessed. The folder 184 allows a date range to be specified, as well as the type of note (e.g., notes about a conversation), the status of the note (e.g., public or private), identity of the person creating the note, the date of the note, and the content of the note. A list is also provided in the screen 184 for allowing quick access to a number of notes. Additionally, a note can be linked to a task or other piece of information by clicking the “Related to” button.

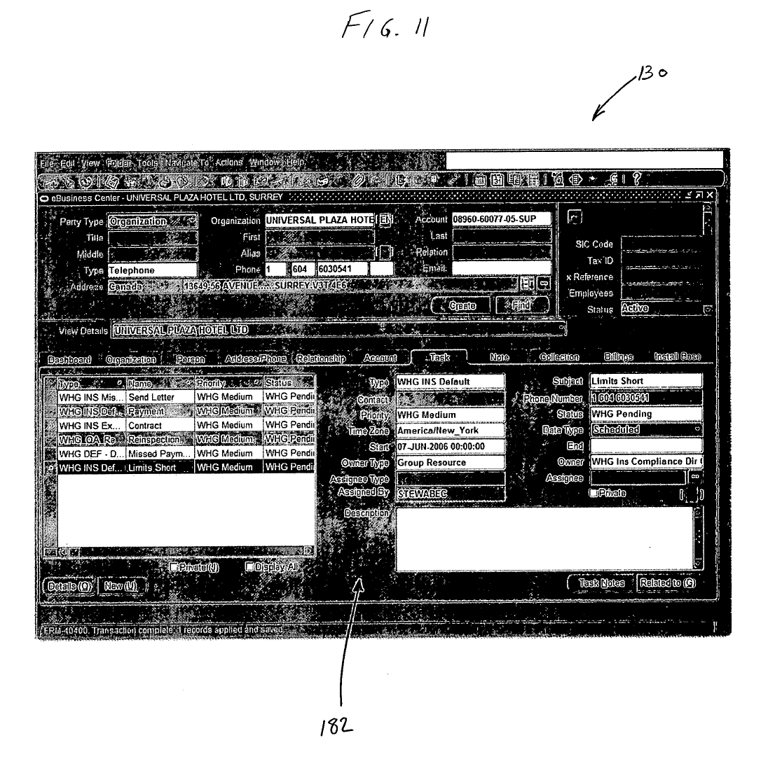

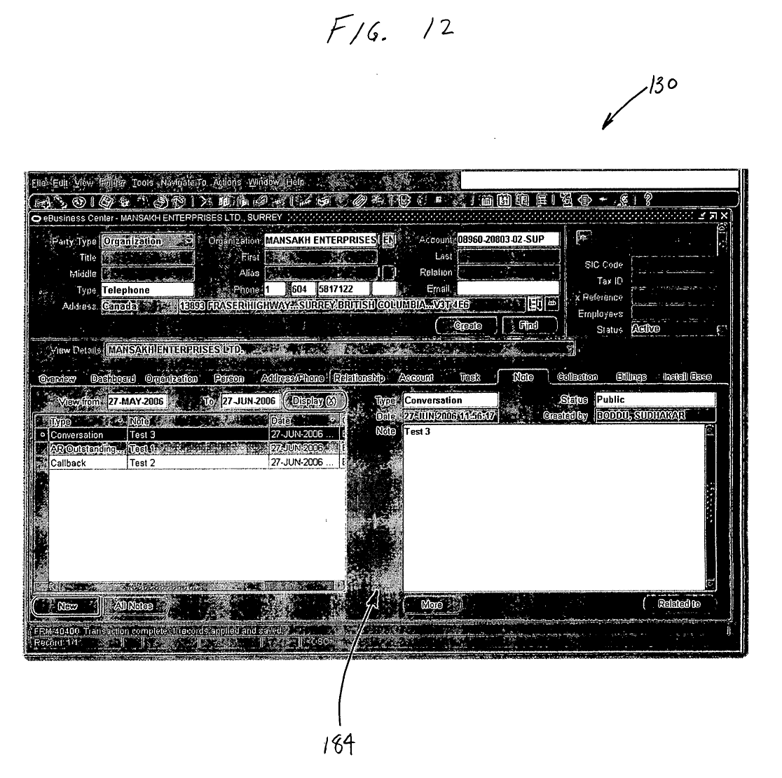

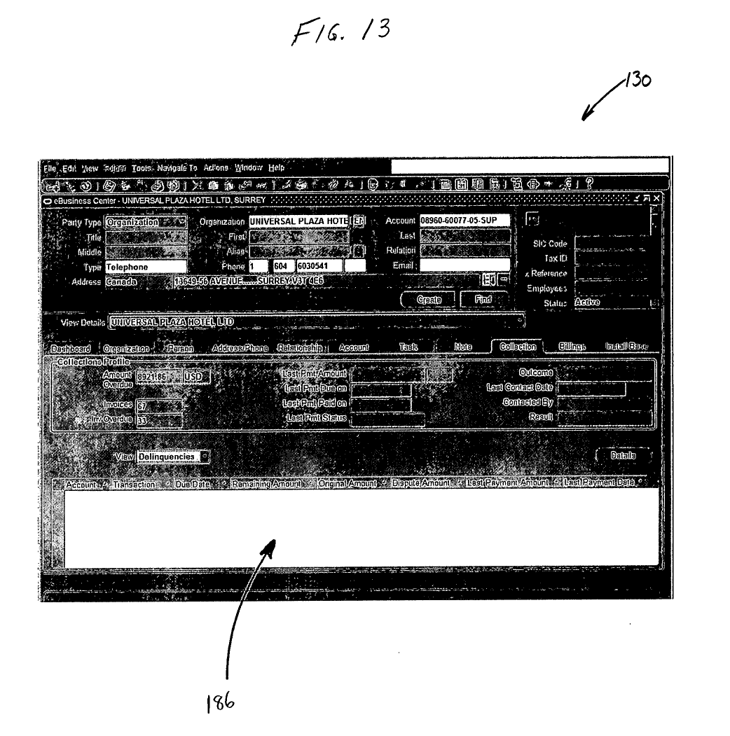

The “Collection” folder 186 of the navigation user interface 130 is shown in FIG. 13. The folder 186 allows for detailed information about financial collections from one or more franchisees to be collected, stored, and accessed. Information stored includes, but is not limited to, amount collected, amount overdue, number of invoices issued, number of overdue invoices, last payment amount, date of last payment due, date of last payment paid, last payment status, outcome of collection action, last contact date, identity of person contacting the franchisee, and result of contact. Additionally, the folder 186 allows for the convenient capture and displaying of delinquency information (such as missed payments, etc.) in tabular format.

The “Billing” folder 188 of the navigation user interface 130 is shown in FIG. 14. The folder 188 allows for detailed information about franchisee billings to be collected, stored, and accessed. The information is presented in tabular format, and includes, but is not limited to, the bill number, a description of the bill, type of currency, bill start and end dates, and bill status, among other information. The bills can be sorted according to type or classification.

The “Install Base” folder 190 of the navigation user interface 130 is shown in FIG. 15. The folder 190 allows for the collection, storage, and accessing of information about various franchise facilities, such as the location of a building and the number of rooms. Detailed information can be accessed by clicking on the “Details” button 192.

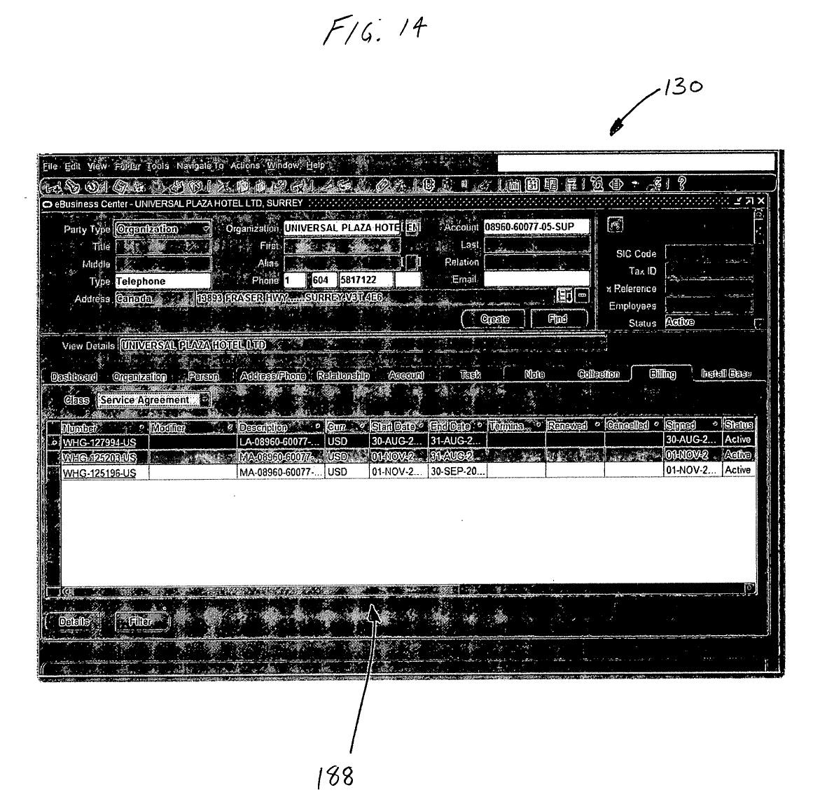

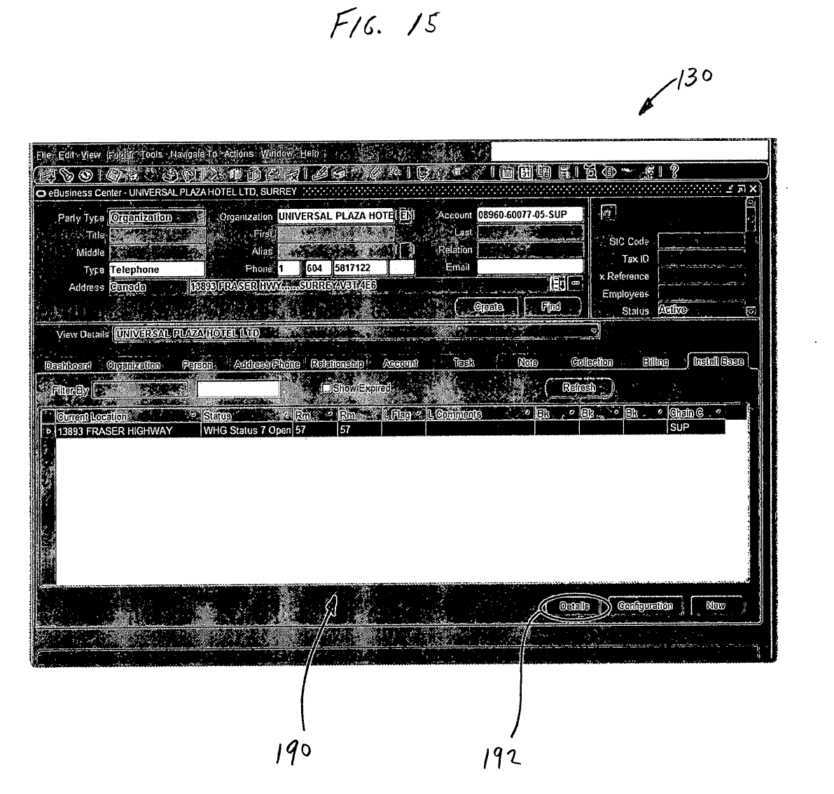

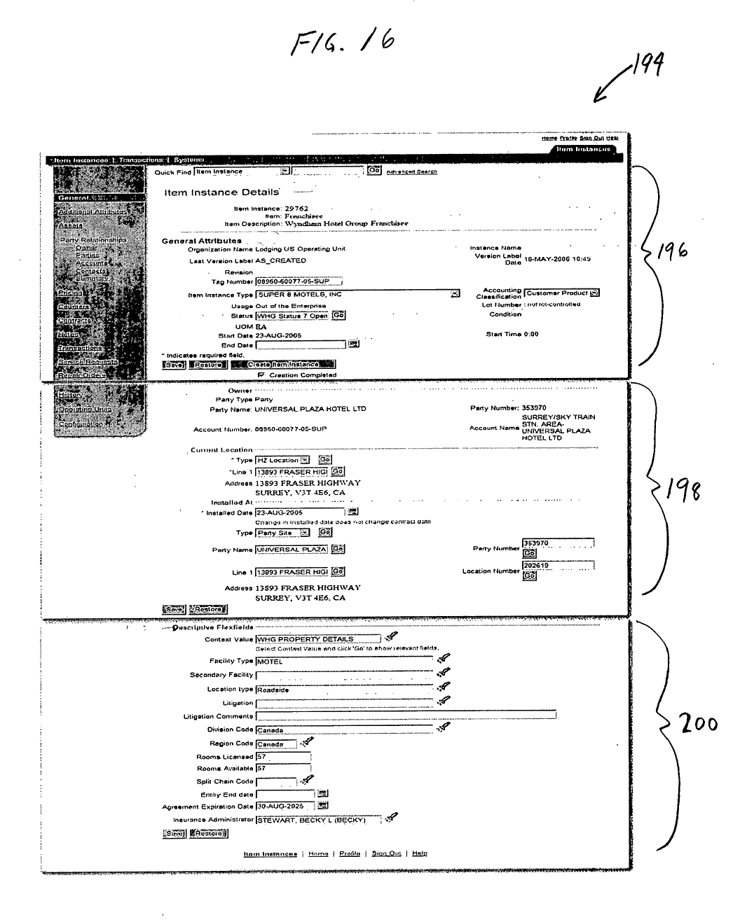

FIGS. 16-20 are screenshots showing a user interface 194 generated by the present invention for collecting, storing, and accessing detailed facility information corresponding to one or more facilities occupied or owned by a franchisee. As shown in FIG. 16, a general attributes region 196 is provided for information relating to general information about a facility, such as site usage, lot number, and condition, among other information. Owner information can be provided in screen region 198, and additional facility information, such as licensed rooms, available rooms, and pending litigation, can be provided in screen region 200. As shown in FIG. 17, additional facility attributes can be specified in screen regions 202 and 204, such as bankruptcy information, brand name, site status, credit representatives, insurance coordinators, previous affiliations, and administrative personnel, among other information. As shown in FIG. 18, transaction information relating to property and/or facility transactions can be tracked in screen region 206. As shown in FIG. 19, information about parties associated with a facility, such as the owner of the facility, can be tracked in screen region 208. As shown in FIG. 20, information about service requests associated with a franchisee facility can be tracked in screen region 210.

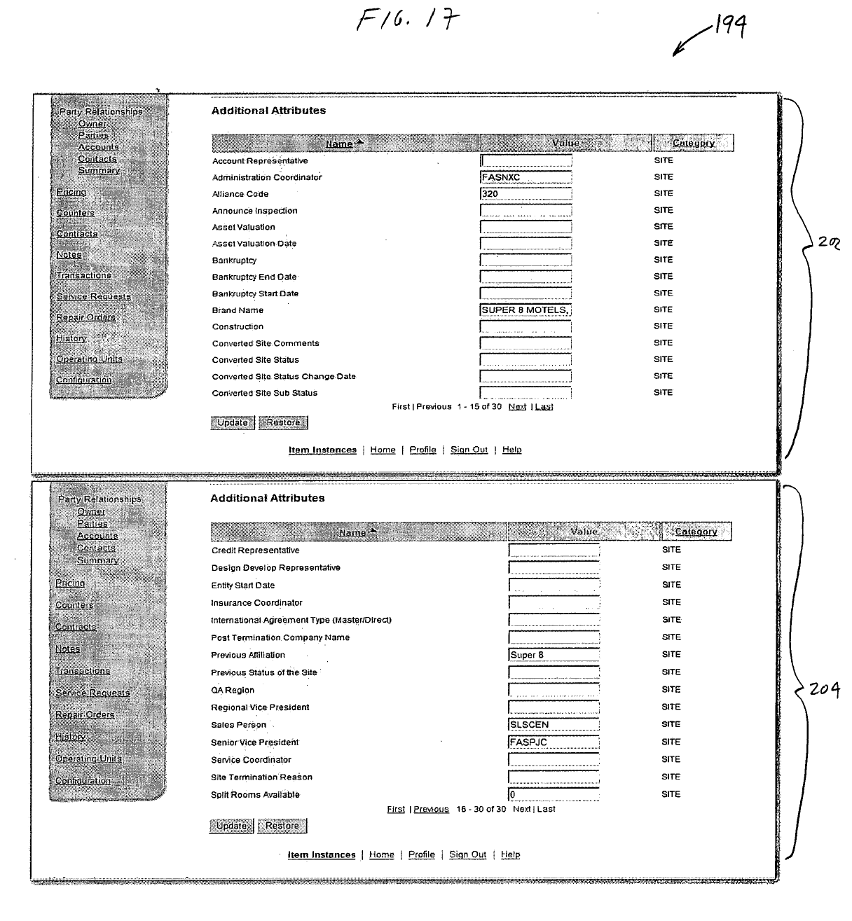

FIG. 21 is a screenshot showing the main user interface screen 220 generated by the present invention. This screen contains a role selection field 222 for allowing a user to click on a role associated with the individual, such as a franchise administrator, a billing manager, a collections supervisor, etc. A “Favorites” field 224 allows the user to quickly access one or more display screens of the present invention, such as the navigation user interface 130 discussed above. The list of favorites could also be edited as desired.

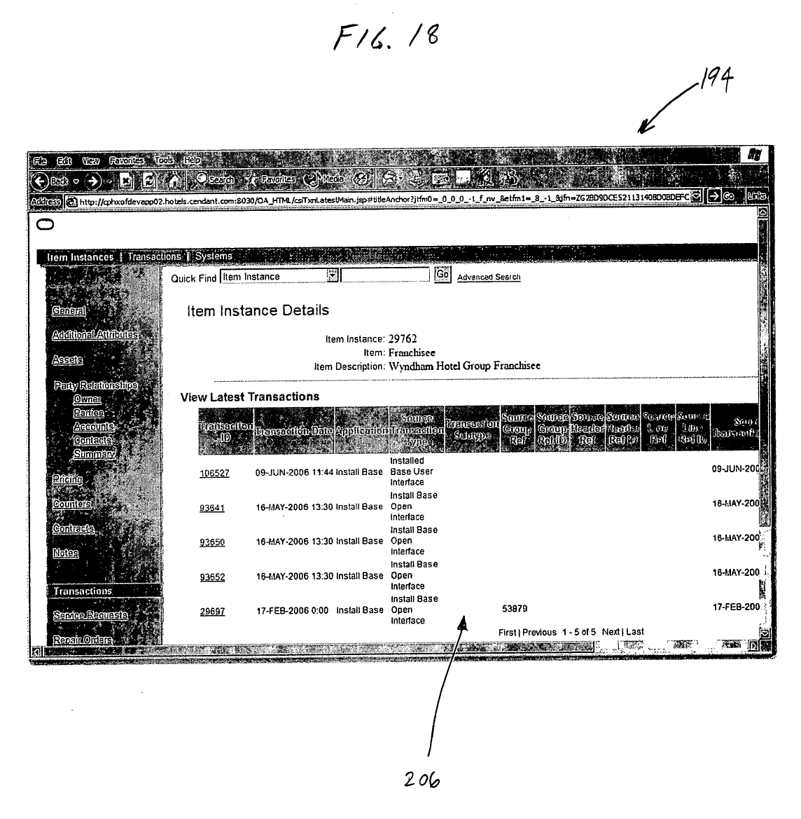

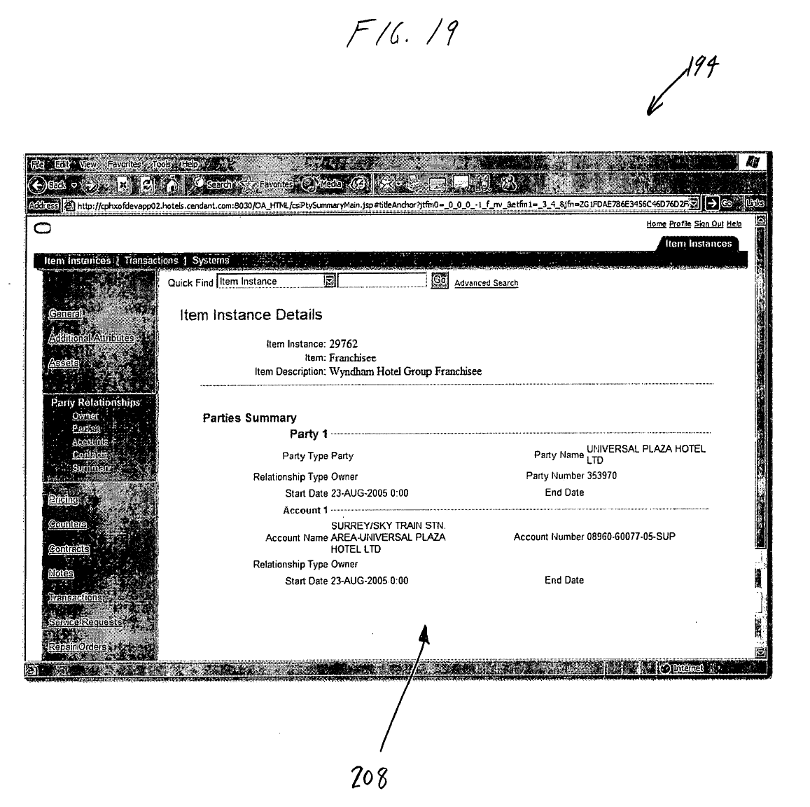

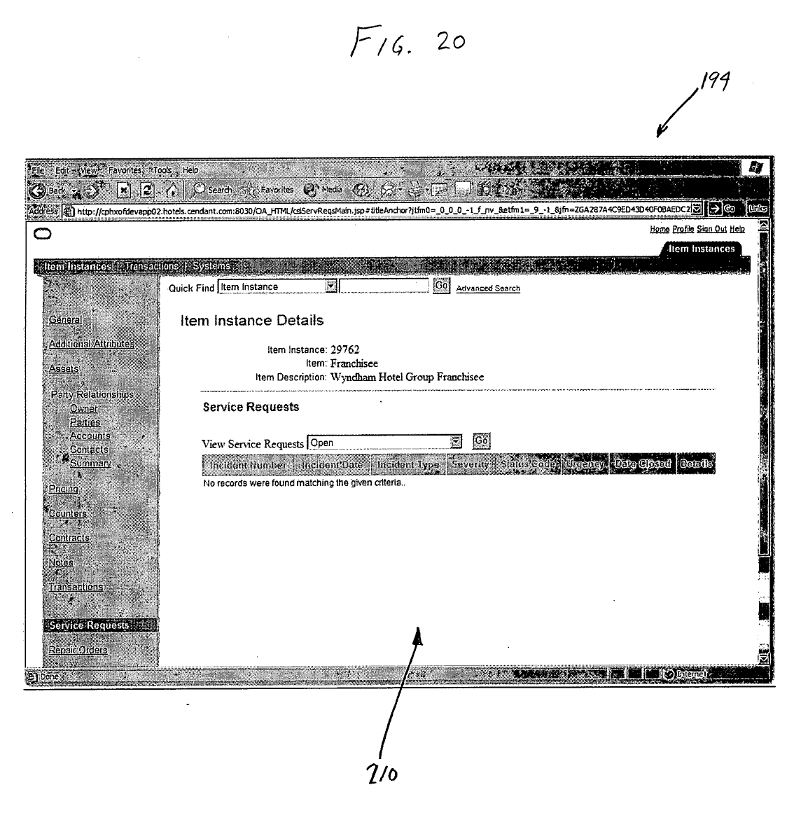

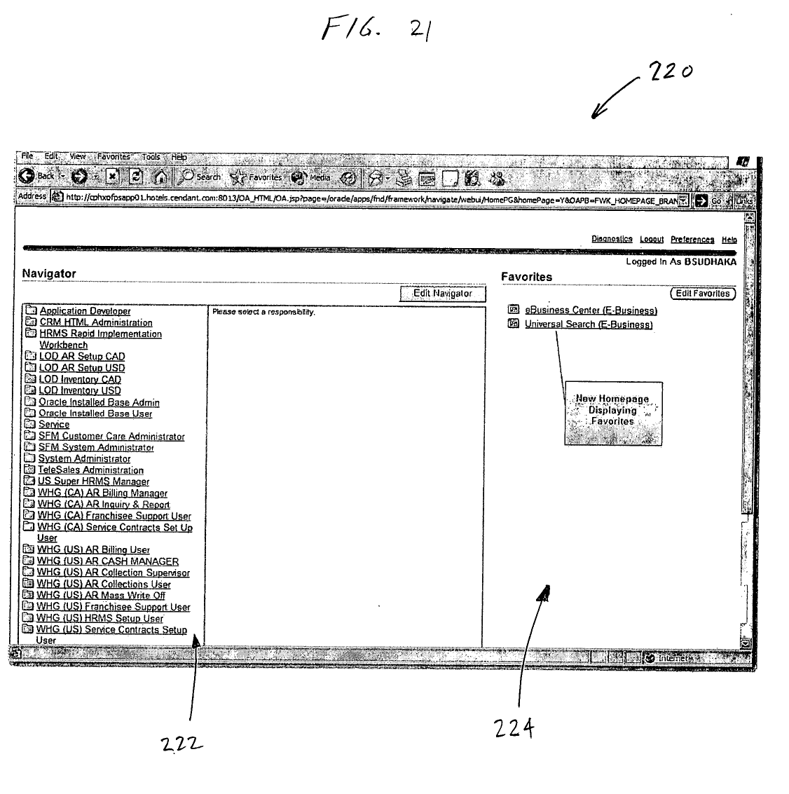

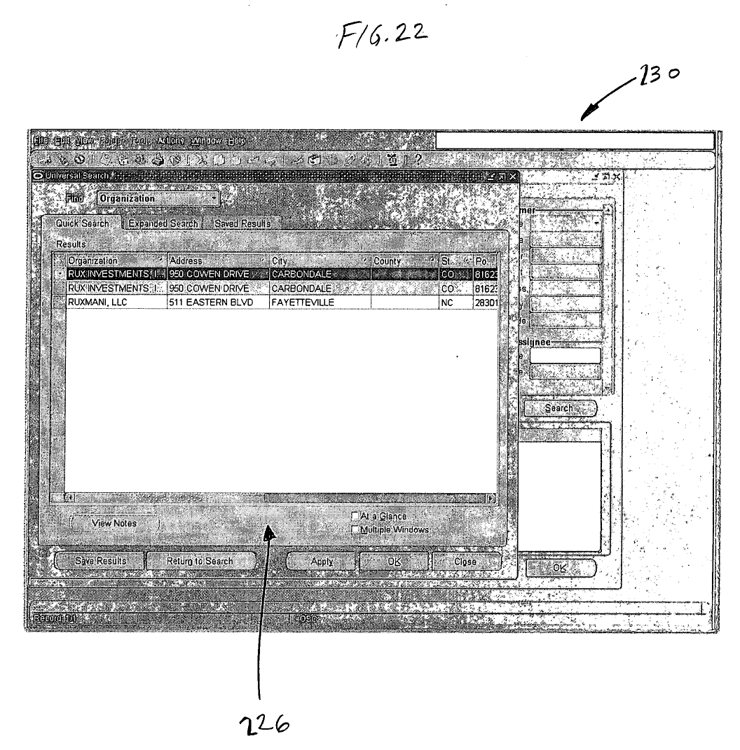

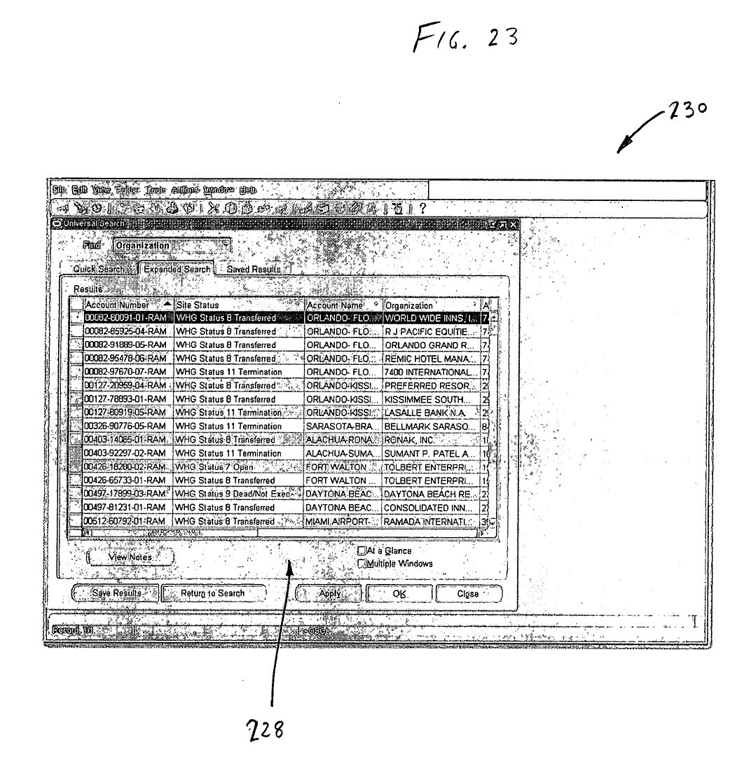

FIGS. 22-24 are screenshots showing user interface screens generated by the present invention for searching for a desired franchise. As shown in FIG. 22, a search screen 230 is provided having a “Quick Search” tab 226 which lists franchise accounts that match a query string and which allow the user to click on a desired franchise account. When the desired franchise account is clicked, the navigation user interface 130 described above is displayed to the user and populated with information about the selected franchise. As shown in FIG. 23, an “Expanded Search” tab 228 could also be displayed by the search screen 230 for displaying search results which match an expanded search query. As shown in FIG. 24, a “Saved Results” tab 230 allows the user to save search results for later reference.

FIG. 25 is a screenshot showing the franchisee information portion 140 of the navigation user interface 130 of the present invention in greater detail. The franchise information portion 140 includes a preferred client contacts link 232, a sites affiliated link 234, and a brands affiliated link 236. The user can click on each of these links to be provided with additional screens with detailed information about a franchisee.

FIGS. 26-28 are screenshots showing user interface screens generated by the present invention for collecting, storing, and accessing information about preferred franchise clients, affiliated sites, and affiliated brands. The preferred clients contact screen 240 shown in FIG. 26 is displayed when the user clicks on the link 232 shown in FIG. 25. The screen 240 allows the user to define, save, and access a list of preferred client contacts, as well as information about the associated franchise account, the contact type, the status of the contact, and the contact's name. The screen 242 shown in FIG. 27 is displayed when the user clicks on the link 234 shown in FIG. 25. The screen 242 allows the user to define, save, and access a list of sites affiliated with the franchisee, as well as information about the associated property number, the name of the property, and the property address. The screen 244 shown in FIG. 28 allows the user to define, save, and access a list of brand names associated with the franchisee.

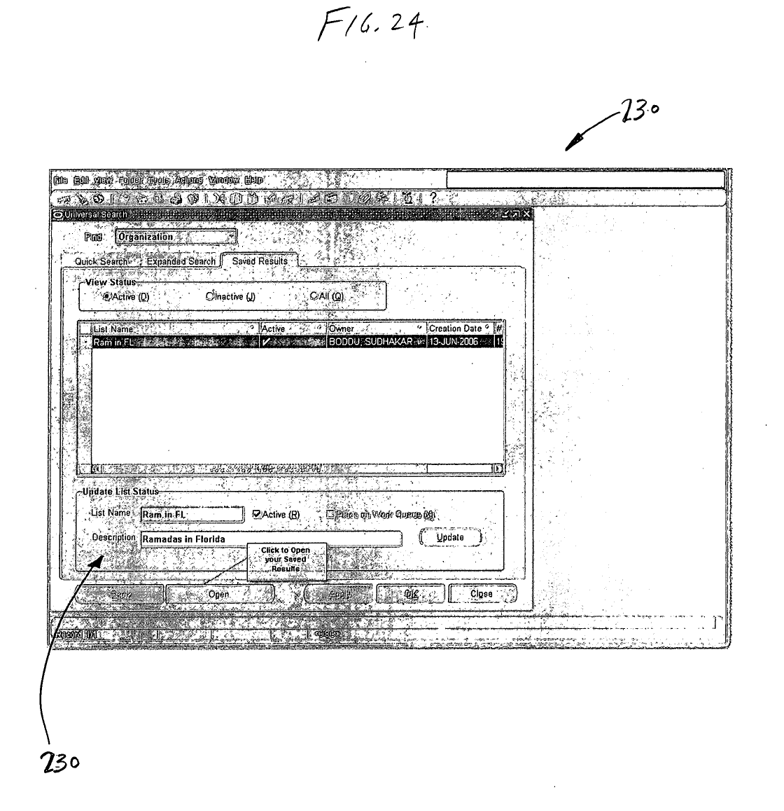

FIGS. 29-30 are screenshots showing the franchise instance portion 142 and the franchise agreement portion 144 of the navigation user interface 130 of the present invention in greater detail. As shown in FIG. 29, the franchise instance portion 142 includes a current site status link 250, a rooms licensed link 252, a rooms available link 254, and an agreement expiration date link 256. The user can click on each of these links to be provided with additional screens with detailed information about a franchise. The franchise agreement portion 144 includes an application and committee approval link 258, a license agreement execution link 260, a stipulations and quality assurance waivers link 262, an amendments link 264, and a third party agreements link 266. Each of these links can be selected by the user so as to provide additional screens with detailed information about a franchise agreement.

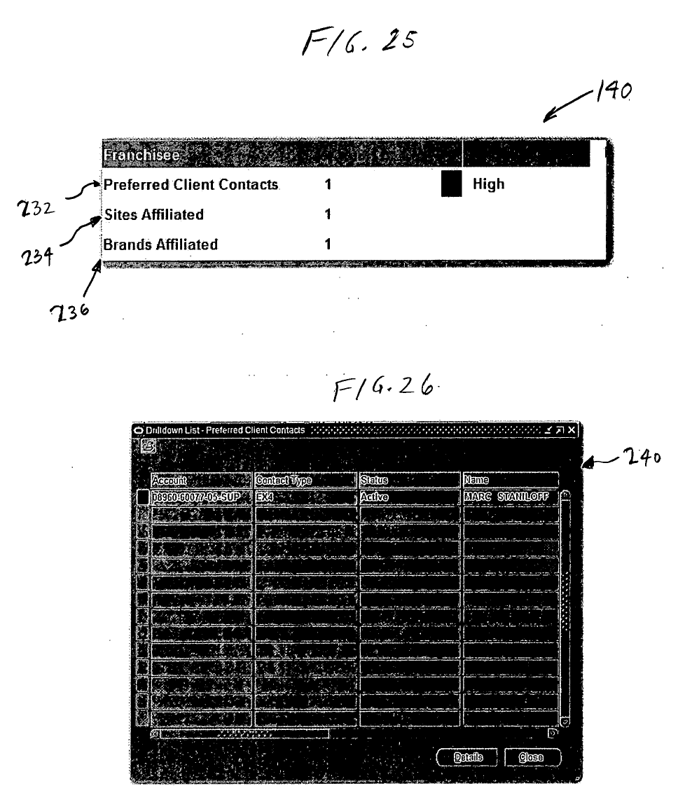

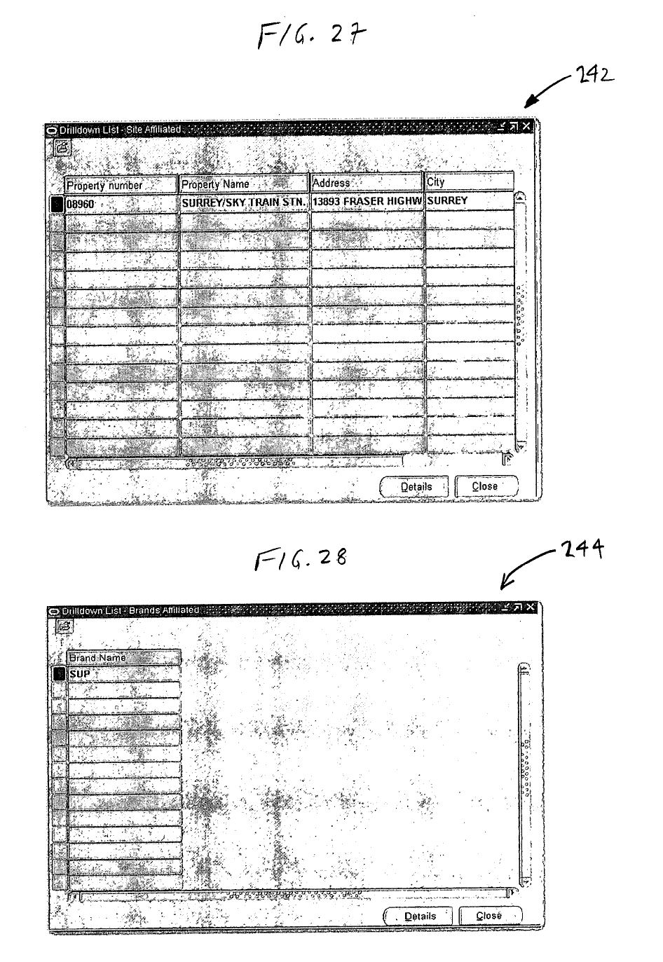

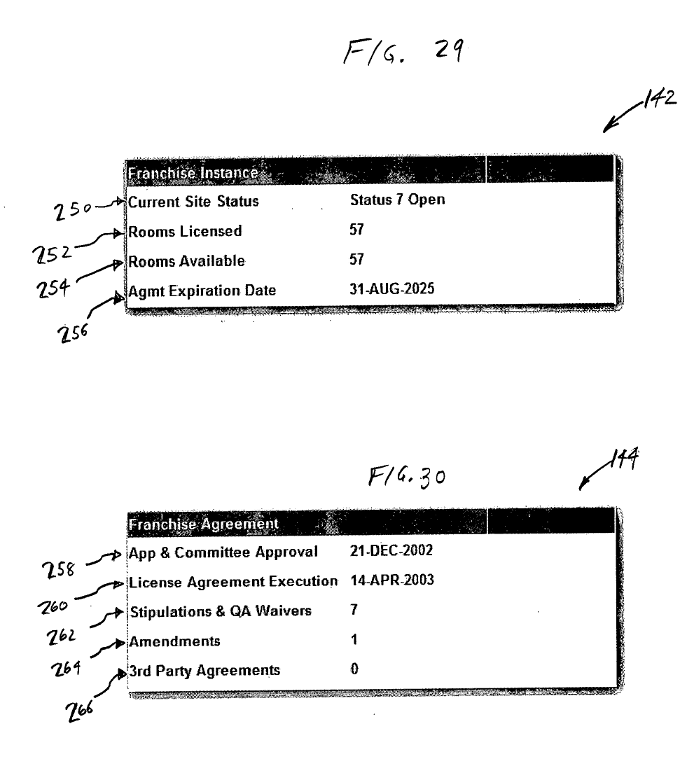

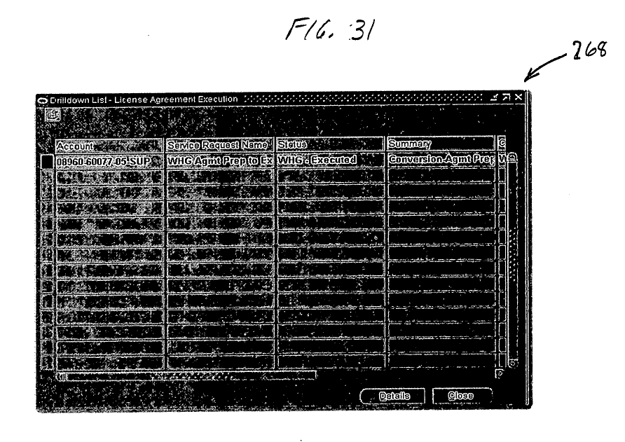

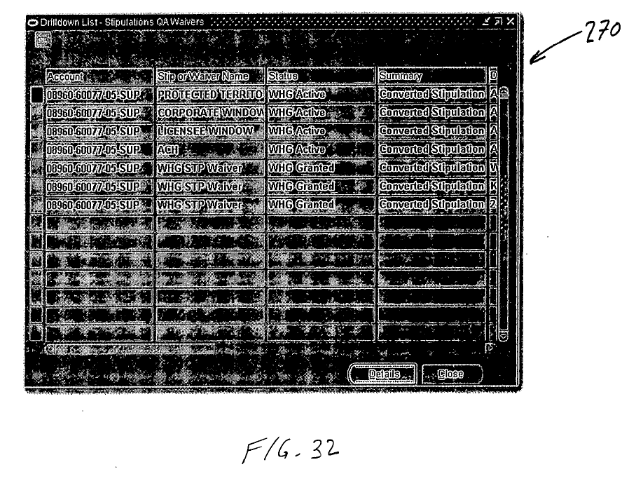

FIGS. 31-34 are screenshots showing user interface screens generated by the present invention for collecting, storing, and accessing information about license agreements, stipulations, contract amendments, and third party agreements. As shown in FIG. 31, a license agreement execution screen 268 provides information about the execution of a franchise license agreement, including the relevant account number, a service request name, the status of the agreement, and a summary of the agreement. As shown in FIG. 32, a stipulations and quality assurance waivers screen 270 provides information about stipulations in a franchise agreement, as well as waivers of quality assurance checks in connection with a franchisee's performance. Fields are provided for collecting, storing, and accessing information relating to relevant account identifiers, stipulation or waiver names, stipulation status, and a summary of each stipulation. The screen 272 shown in FIG. 33 provides information about amendments to existing franchise agreements, such as a relevant account identifier, a service request name associated with the amendment, a status field, and a summary field. Similarly, the screen 274 shown in FIG. 34 provides account identifier, service request name, status, and summary fields for recording information about third-party agreements.

FIG. 35 is a screenshot showing the construction information portion 146 of the navigation user interface 130 of the present invention in greater detail. A construction and ground breaking link 280, a design services link 282, an opening link 284, and a billing commencement date link 286 are provided for selectively accessing user interface screens for tracking detailed information about one or more construction projects associated with a franchise.

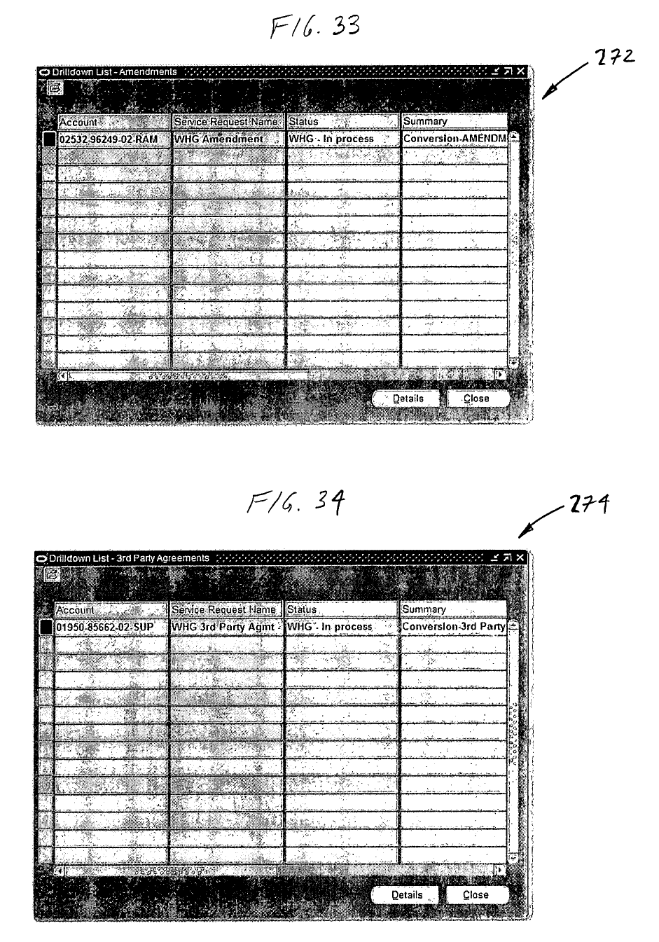

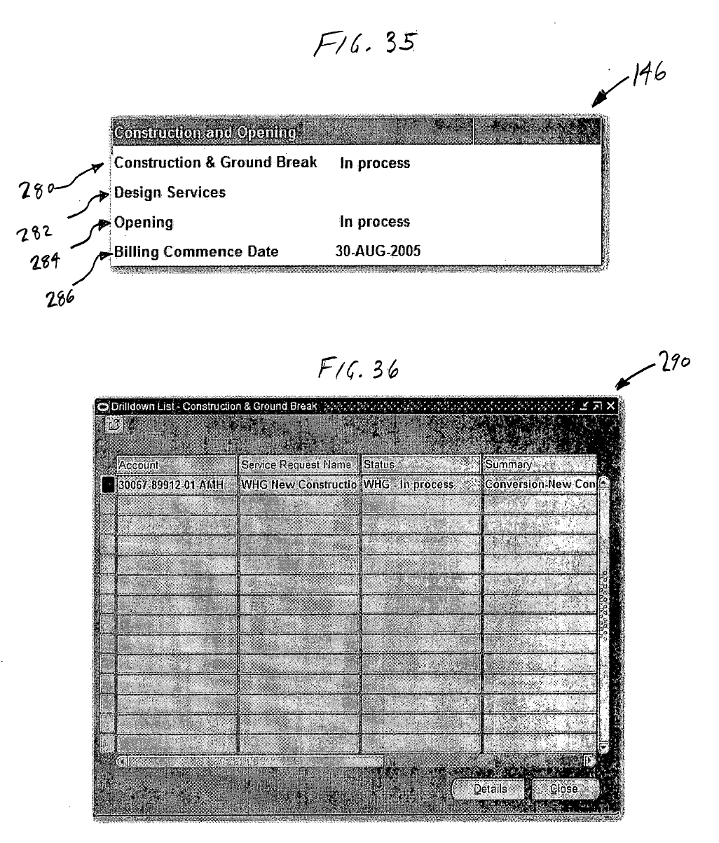

FIGS. 36-37 are screenshots showing user interface screens generated by the present invention for collecting, storing, and accessing information about construction projects. The screen 290 shown in FIG. 36 is displayed when the user clicks on the construction and ground breaking link 280 shown in FIG. 35. This screen provides account information, service request name, status, and summary fields for recording information about a construction project or ground breaking event associated with a franchise. The screen 292 shown in FIG. 37 is displayed when the user clicks on the opening link 284 shown in FIG. 35, and provides account information, service request name, status, and probability of opening fields for recording information about the opening of a franchise location. Importantly, the probability of a site opening on time can be determined using the screen 292, based upon the status of one or more construction projects. Probabilities could be expressed as low, normal, or high.

FIG. 38 is a screenshot showing the financial information portion 148 of the navigation user interface 130 of the present invention in greater detail. An aging summary link 294, an open transactions link 296, an operating statistics link 298, a reservation operating statistics link 300, a license rates link 302, a work out agreement link 304, a stipulations link 306, and an open credits/unapplied cash link 308 are provided for accessing user interface screens for collecting, storing, and accessing detailed financial information relating to a franchise.

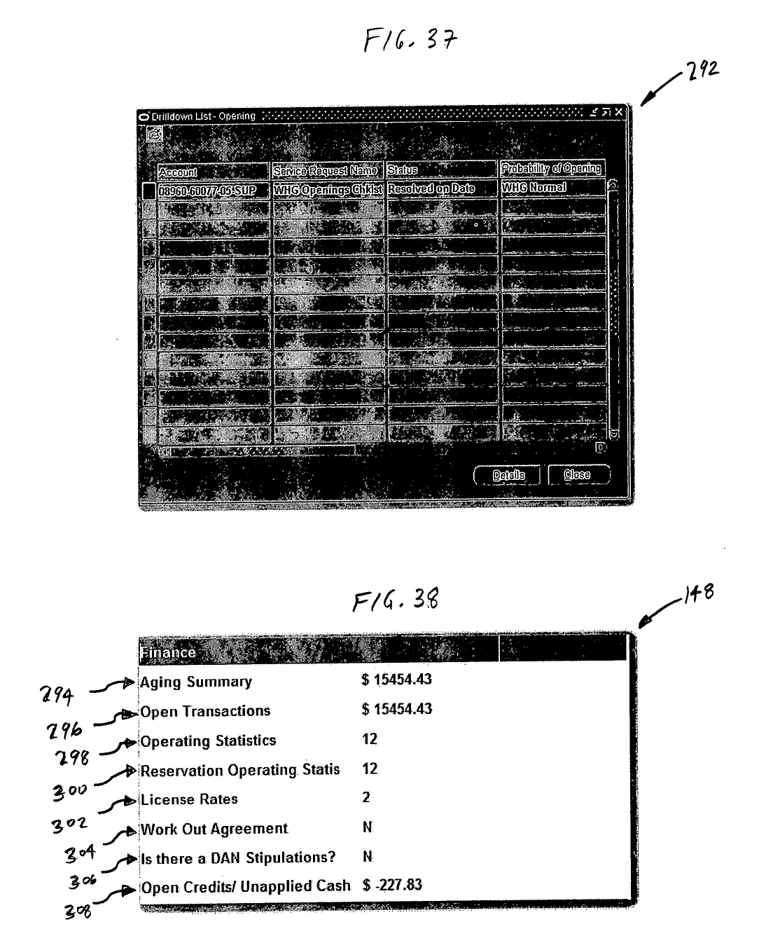

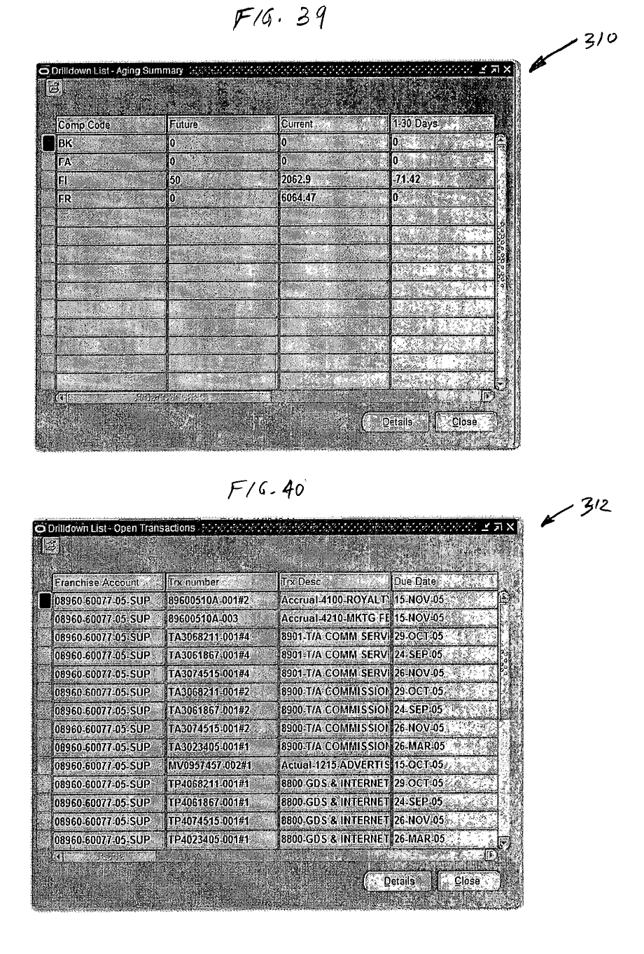

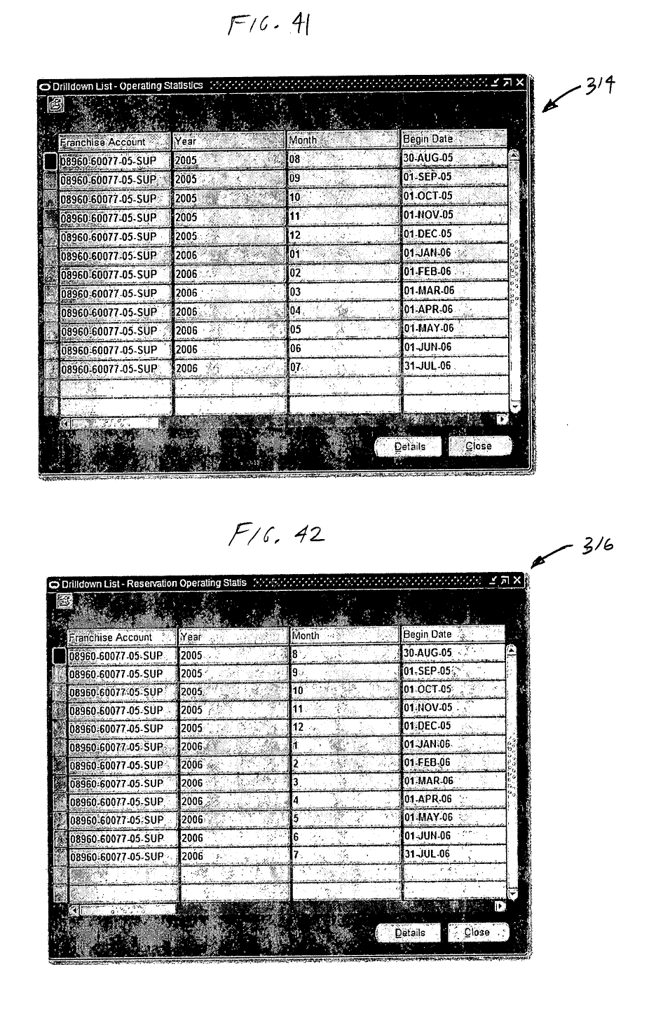

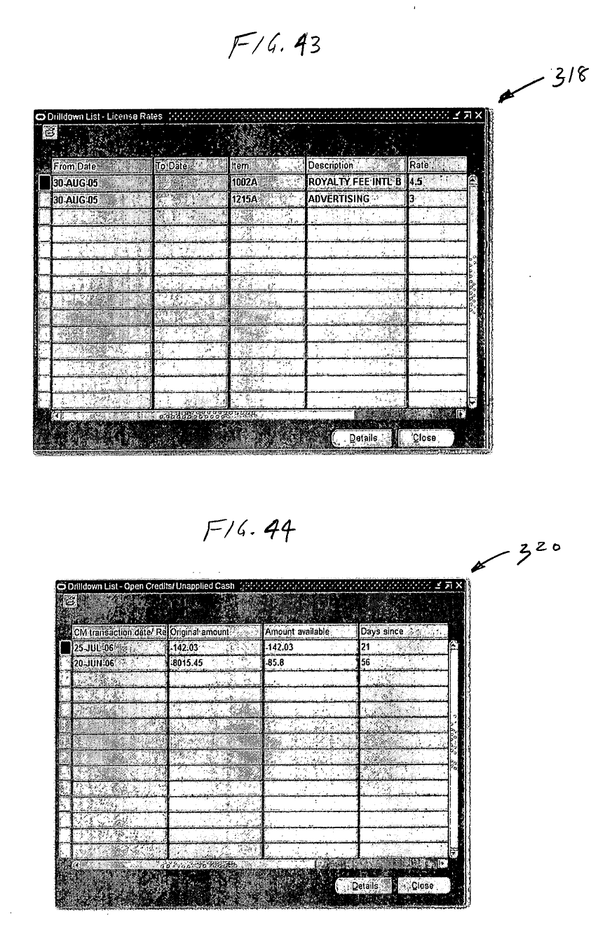

FIG. 39-44 are screenshots showing user interface screens generated by the present invention for collecting, storing, and accessing information about accounts receivable, open transactions, operating statistics, reservation statistics, license rates, and available credits and/or cash. The screen 310 shown in FIG. 39 is displayed when the user clicks on the aging summary link 294 shown in FIG. 38, and contains information about financial codes as well as current and future accounts receivable (uncollected revenue) associated with a particular franchise. The screen 312 shown in FIG. 40 is displayed when the user clicks on the open transactions link 296 shown in FIG. 38, and contains information about franchise accounts, transaction numbers, transaction descriptions, and due dates relating to financial transactions associated with a franchise. The screen 314 of FIG. 41 is displayed when the user clicks on the operating statistics link 298 shown in FIG. 38, and contains information about operating statistics associated with a franchise, such as account numbers, years, months, and beginning dates. The screen 316 of FIG. 42 is displayed when the user clicks on the reservation operating statistics link 300 shown in FIG. 38, and contains information about reservations associated with a franchise, including account numbers, years, months, and beginning dates. The screen 318 of FIG. 43 is displayed when the user clicks on the license rates link 302 shown in FIG. 38, and contains information about starting and ending dates, items, descriptions, and rates associated with franchise licenses. The screen 320 of FIG. 44 is displayed when the user clicks on the open credits/unapplied cash link 308 shown in FIG. 38, and contains information about open credits and/or unapplied cash, such as transaction dates, credit amounts, available amounts, and days since the last transaction.

FIG. 45 is a screenshot showing the compliance information portion 322 of the navigation user interface 130 of the present invention. The compliance information portion 322 allows a user to collect, store, and access information about a franchisee's compliance with franchise agreement stipulations, as well as a franchisee's default history. A Central Reservation System (CRS) restrictions link 324, an active defaults link 326, a cured defaults link 328, a compliance action pending link 330, a quality assurance results link 322, an insurance link 334, a termination link 336, an agreement termination date link 338, and a reinstatement link 340 are provided for accessing user interface screens for collecting, storing, and accessing detailed compliance information.

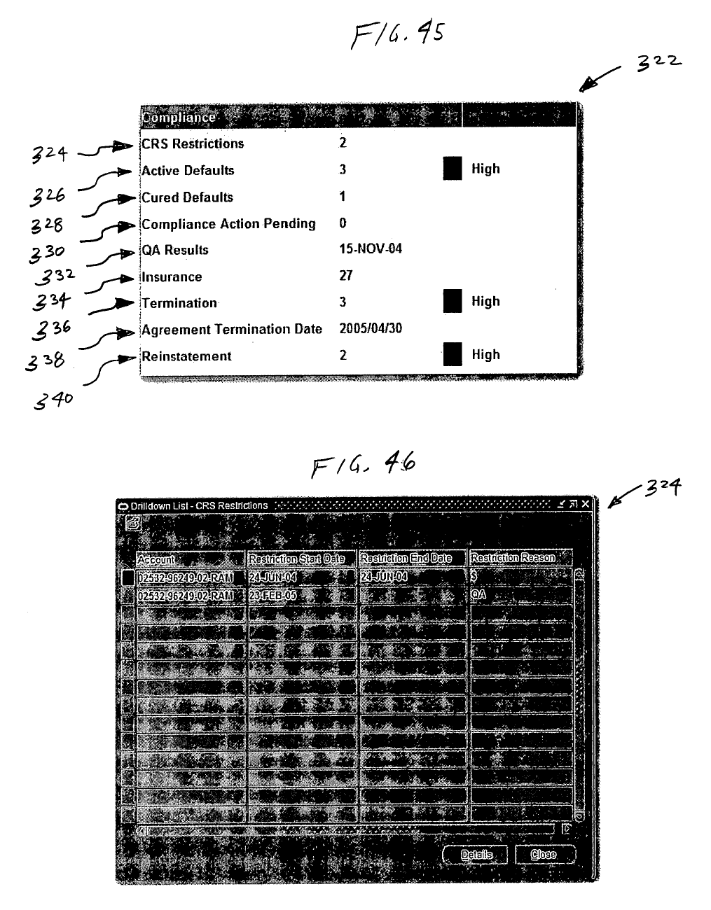

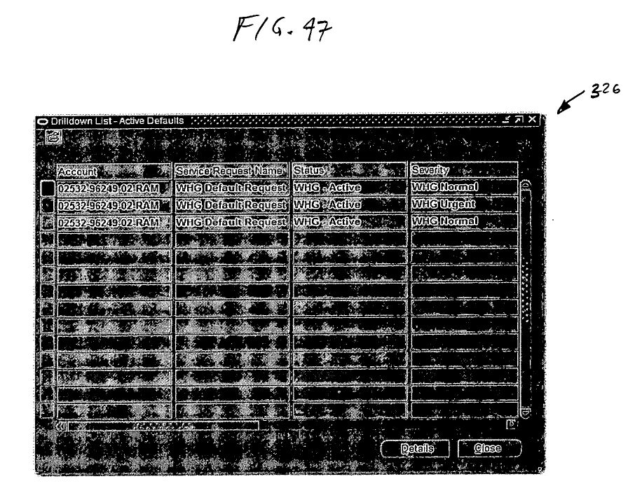

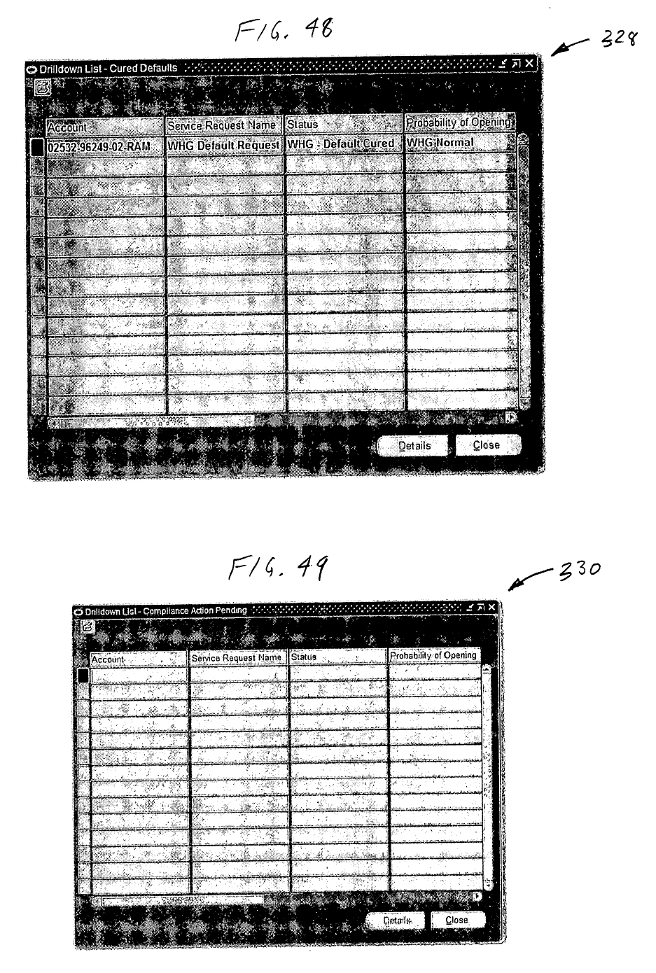

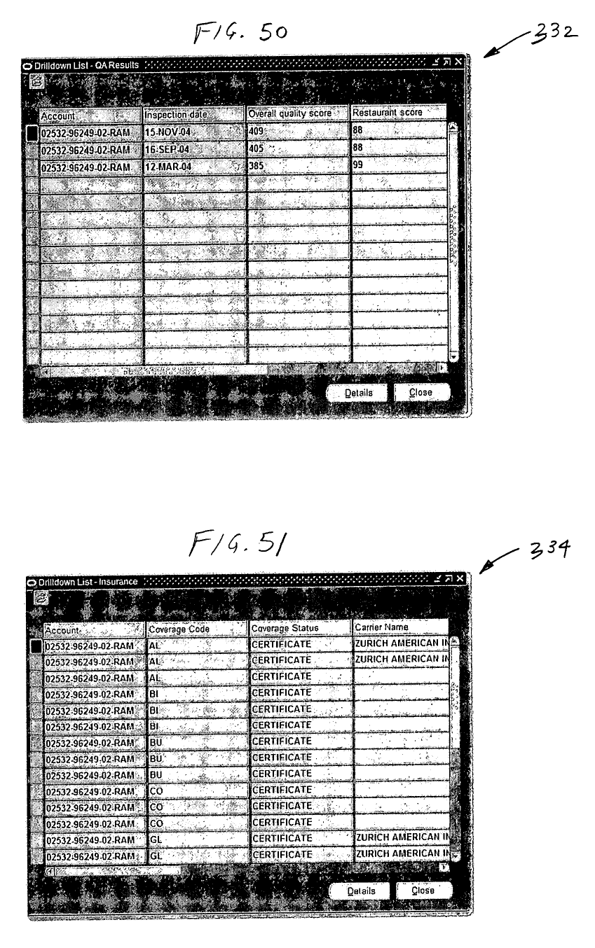

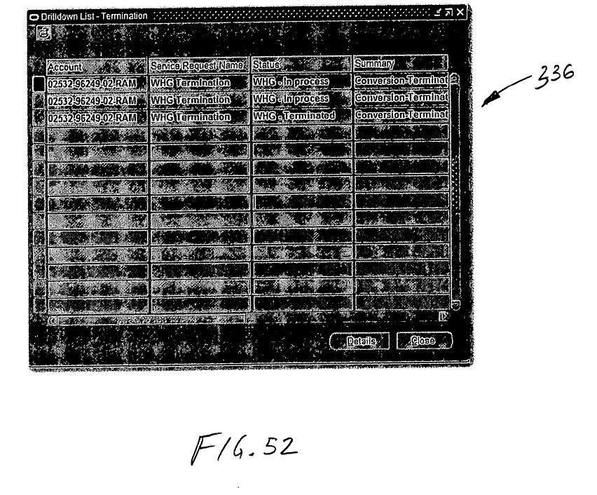

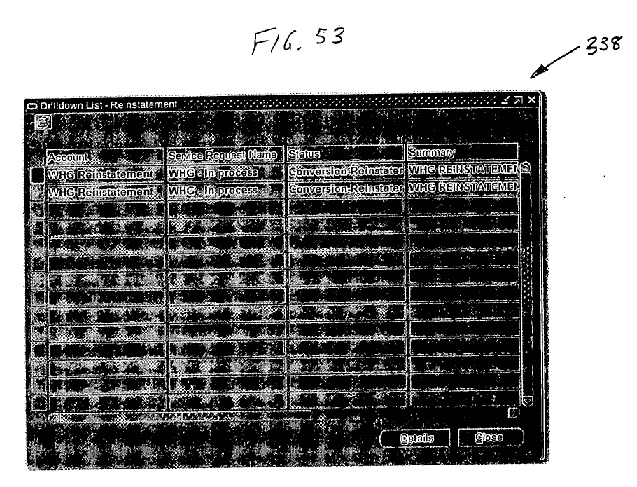

FIGS. 46-53 are screenshots showing user interface screens generated by the present invention for collecting, storing, and accessing information about compliance restrictions, active defaults, cured defaults, pending compliance actions, quality assurance results, insurance carriers, terminated franchises, and reinstated franchises. The screen 324 shown in FIG. 46 allows for account information, restriction start date, restriction end date, and restriction reasons to be recorded relating to one or more CRS restrictions, and is displayed when the link 324 shown in FIG. 45 is selected. The screen 326 shown in FIG. 47 allows for account information, service request names, status information, and severity indicators to be recorded relating to one or more active defaults by a franchisee, and is displayed when the link 326 shown in FIG. 45 is selected. The screens 328 and 330 shown FIGS. 48 and 49 allow for account information, service request names, status information, and probabilities of opening an account based upon a franchisee's default history to be recorded in connection with cured defaults and pending compliance actions, and are displayed when the links 328 and 330 shown in FIG. 45 are selected. The screen 332 shown in FIG. 50 allows for account information, inspection dates, overall quality scores, and restaurant scores to be recorded in connection with a quality insurance inspection of a franchisee site, and is displayed when the link 332 shown in FIG. 45 is selected. The screen 334 shown in FIG. 51 allows for account information, coverage codes, coverage status information, and insurance carrier names to be recorded in connection with a franchisee's insurance carrier, and is displayed when the link 334 shown in FIG. 45 is selected. The screen 336 shown in FIG. 52 allows for account information, service request names, status information, and summary information to be recorded in connection with terminated franchise agreements, and is displayed when the link 338 shown in FIG. 45 is selected. The screen 338 shown in FIG. 53 allows for account information, service request names, status information, and summary information to be recorded in connection with reinstated franchise agreements, and is displayed when the link 340 shown in FIG. 45 is selected.

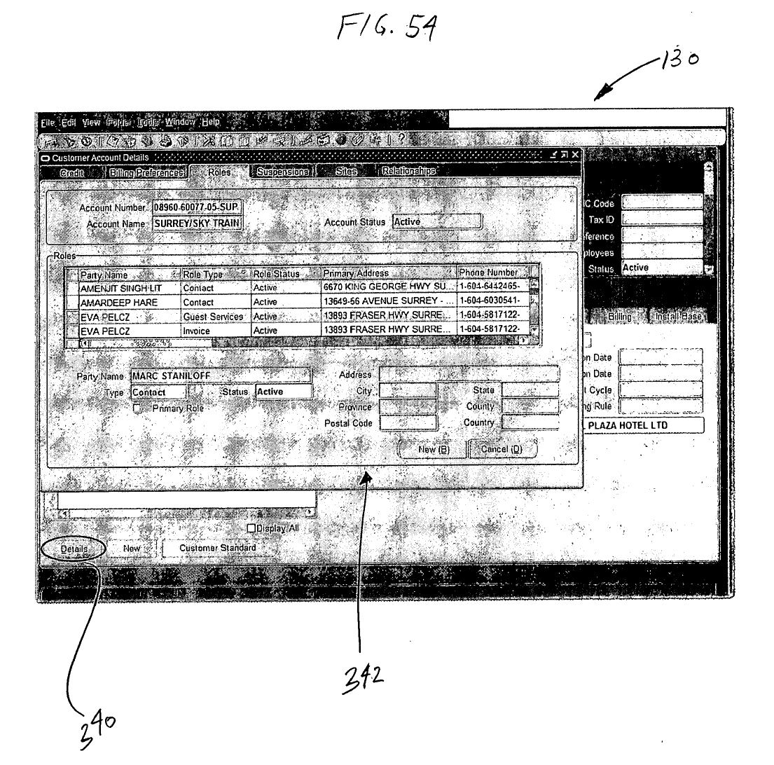

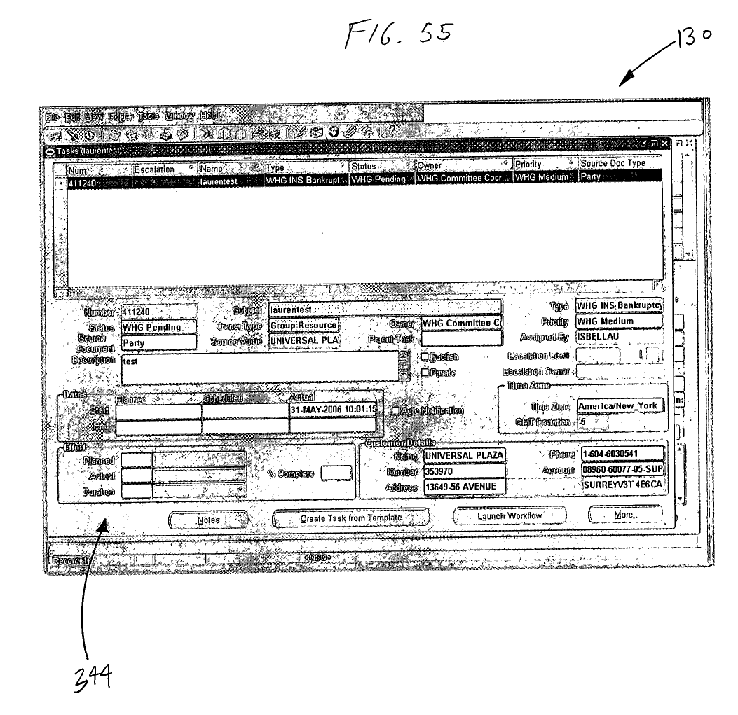

FIG. 54 is a screenshot showing a user interface screen 342 generated by the navigation user interface 130 of the present invention for collecting, storing, and accessing information about a franchise account. Information about account credit, client billing preferences, individual roles, account suspensions, sites, and relationships can be recorded. The “Roles” folder is displayed in FIG. 54, and allows for information about various roles associated with franchise individuals to be recorded, including role types, role status, and contact information of each individual. By clicking on the “Details” button 340, additional detailed information about the account can be recorded.

FIG. 55 is a screenshot showing a user interface screen 344 generated by the navigation user interface 130 of the present invention for defining compliance monitoring tasks to be performed in connection with a franchise. The screen 344 records specific task information such as task number, escalation indicators (i.e., indicators of whether one or more tasks should be escalated in importance over other tasks), task type, status, owner, priority indicators, and source document type, can be collected, stored, and accessed. More detailed information about a selected task is displayed in the lower half of the screen 344, including information about task efforts and customer details.

Having thus described the invention in detail, it is to be understood that the foregoing description is not intended to limit the spirit or scope thereof. What is desired to be protected by Letters Patent is set forth in the appended Claims.

What is claimed is:

1. A franchise administration system, comprising:
a central server for receiving and processing information relating to a franchise business, the central server in communication with a computer system operated by a user associated with the franchise business;
a plurality of user interface screens displayed by the computer system for allowing the user to provide information about the franchise business and to define stipulations associated with a franchise agreement, said information and said stipulations transmitted to said central server;
means at said central server for monitoring a franchisee's performance over time and determining whether said stipulations have been met; and
means at said central server for notifying the user of a default by the franchisee if said means for monitoring determines that one or more of said stipulations have not been met by the franchisee.

2. The system of claim 1, wherein the user comprises a franchisee, a franchise administrator, a property manager, a construction manager, a compliance officer, quality assurance personnel financial personnel, or marketing personnel.

3. The system of claim 1, wherein said central server further comprises means for classifying a default by the franchisee according to a severity of the default.

4. The system of claim 3, wherein the default and a classification of the default are transmitted from the central server to a system administrator.

5. The system of claim 1, wherein the central server generates and transmits a default notification to the franchisee.

6. The system of claim 5, wherein the central server monitors for a predetermined period of time for a cure of the default by the franchisee.

7. The system of claim 6, wherein the central server reports a cure to the user if the franchisee cures the default within the predetermined period of time.

8. The system of claim 5, wherein the central server determines whether the franchisee disputes the default.

9. The system of claim 8, wherein the central server processes the dispute if the franchisee disputes the default.

10. The system of claim 8, wherein the central server sends a notification to a legal department requesting action against the franchisee if the central server determines that the franchise has not cured the default and does not dispute the default.

11. The system of claim 1, wherein the plurality of user interface screens comprises a screen for collecting, storing, and accessing information about a facility operated by the franchisee.

12. The system of claim 1, wherein the plurality of user interface screens comprises a screen for searching for a desired franchisee.

13. The system of claim 1, wherein the plurality of user interface screens comprises a screen for collecting, storing, and accessing information about clients of the franchisee.

14. The system of claim 13, wherein the plurality of user interface screens comprise a screen for collecting, storing and accessing information about a site affiliated with a franchisee.

15. The system of claim 14, wherein the plurality of user interface screens comprise a screen for collecting, storing, and accessing information about a brand affiliated with a franchisee.

16. The system of claim 1, wherein the plurality of user interface screens comprises a screen for collecting, storing, and accessing information about the franchise agreement.

17. The system of claim 1, wherein the plurality of user interface screens comprises a screen for collecting, storing, and accessing information about construction occurring at a franchisee location.

18. The system of claim 1, wherein the plurality of user interface screens comprises a screen for collecting, storing, and accessing financial information about the franchisee.

19. The system of claim 1, wherein the plurality of user interface screens comprises a screen for collecting, storing, and accessing operating statistics about the franchisee.

20. The system of claim 1, further comprising an optical character recognition (OCR) subsystem in communication with the central server for capturing franchise information from hardcopy documents.

21. The system of claim 1, further comprising means at said central server for generating and transmitting a reminder to the franchisee to perform a task specified by the franchise agreement.

22. The system of claim 21, wherein said means for transmitting the reminder requests the franchisee to acknowledge that the task has been performed.

23. A method for administering a franchise, comprising the steps of:
displaying a plurality of user interface screens to a user at a computer system in communication with a central server;
allowing the user to provide information about a franchise business and to define stipulations associated with a franchise agreement using said plurality of user interface screens;
transmitting said information and said stipulations to said central server;
monitoring a franchisee's performance over time using said central server;
determining at said central server whether said stipulations have been met by the franchisee; and
notifying the user of a default by the franchisee if the one or more of said stipulations have not been met by the franchisee.

24. The method of claim 23, further comprising classifying the default according to a severity of the default.

25. The method of claim 24, further comprising transmitting the default and a classification of the default to a system administrator.

26. The method of claim 23, further comprising generating and transmitting a default notification from said central server to the franchisee.

27. The method of claim 26, further comprising monitoring for a predetermined period of time for a cure of the default by the franchisee.

28. The method of claim 27, further comprising reporting a cure to the user if the franchisee cures the default within the predetermined period of time.

29. The method of claim 26, further comprising determining at said central server whether the franchisee disputes the default.

30. The method of claim 29, further comprising processing the dispute at said central server if the franchisee disputes the default.

31. The method of claim 30, further comprising sending a notification from said central server to a legal department requesting action against the franchisee if said central server determines that the franchise has not cured the default and does not dispute the default.

32. The method of claim 23, further comprising generating and transmitting a reminder to the franchisee to perform a task specified by the franchise agreement.

33. The method of claim 32, further comprising requesting the franchisee to acknowledge that the task has been performed.
